(19) United States
(12) Patent Application Publication
(10) Pub. No.: US 2023/0341574 A1
(43) Pub. Date: Oct. 26, 2023

(54) SYSTEM AND METHOD FOR UTILIZING GRAVITATIONAL WAVES FOR GEOLOGICAL EXPLORATION

(71) Applicant: Terahertz Ventures LLC, Saratoga Springs, UT (US)

(72) Inventors: Michael John Harney, Saratoga Springs, UT (US); Mario Ninic, Sandy, UT (US); Kim Mansfield, Lehi, UT (US); Brian D. Owens, Plano, TX (US)

(73) Assignee: Terahertz Ventures LLC, Saratoga Springs, UT (US)

(21) Appl. No.: 18/156,119

(22) Filed: Jan. 18, 2023

Related U.S. Application Data
(60) Provisional application No. 63/300,585, filed on Jan. 18, 2022.

(51) Int. Cl. G01V 1/28; G01V 1/00

(52) U.S. Cl. CPC G01V 1/282; G01V 1/003

(57) ABSTRACT

A system, method, and devices for locating natural resources. Sensor measurements are captured at locations utilizing sensor instructions including at least an accelerometer. The sensor measurements are converted into digital data. A fast fourier transform is performed on the digital data. The natural resources are identified proximate the locations utilizing the digital data. Triangulation is performed for the nature resources that are identified. A report is generated showing predictions for the natural resources and triangulation data for the natural resources.

### PRIORITY

This application claims priority to U.S. Provisional Patent Application No. 63/300,585 filed Jan. 18, 2022, titled SYSTEM AND METHOD FOR UTILIZING GRAVITATIONAL WAVES FOR GEOLOGICAL EXPLORATION, all of which is hereby incorporated by reference in their entity.

### BACKGROUND

The Laser Interferometer Gravitational-Wave Observatory (LIGO) is a large-scale physics experiment and observatory designed to detect cosmic gravitational waves and to develop gravitational-wave observations as an astronomical tool. These observatories use mirrors spaced four kilometers apart which are capable of detecting a change of less than one ten-thousandth the charge diameter of a proton. LIGO has provided valuable confirmation of predictions around gravitational waves. Various notable scientists have predicted gravitational waves would be observed in the frequency bands of 10⁻⁸ Hz to 10¹¹ Hz.

The Laser Interferometer Space Antenna (eLISA) is in a unique position to detect the lower end of this range at around 10⁻⁵ Hz, where it should be able to measure the signal of gravitational waves from the static potential due to the earth and moon. The European Pulsar Timing Array (EPTA) has high sensitivity in the 10⁻⁸ Hz range where it should be able to measure the static gravitational waves from the sun.

It is estimated that LIGO has cost approximately 1.1 billion and eLISA may cost approximately 1 billion. As a result, utilization of gravitational waves or signals by the average individual, company, or entity for any practical applications seems unreachable at the moment without significant breakthroughs in our understanding and processing of these waves/signals.

In addition, natural resource exploration and composition determinations (e.g., minerals or contaminants in water, ores in stone, water or contaminants in the human body, etc.) are very difficult to perform without costly and invasive systems, devices, and techniques, such as drilling, seismic testing, and so forth. For natural resources that are far underground determining locations and quantities of precious metals, water, oil, gas, and other materials is very difficult. Existing solutions have not changed significantly in recent years and often require costly, time intensive, physical, and environmentally unfriendly techniques, processes, machinery/systems, and methods.

### SUMMARY

The illustrative embodiments provide a system, method, and devices for identifying and locating natural resources. Sensor measurements are captured at locations utilizing sensor instructions including at least an accelerometer. The sensor measurements are converted into digital data. A fast Fourier transform (FFT) is performed on the digital data. The natural resources are identified proximate the locations utilizing the digital data. Triangulation is performed for the nature resources that are identified. A report is generated showing predictions for the natural resources and triangulation data for the natural resources.

In alternative embodiments, the sensor measurements are captured at a frequency of or greater than 1 Hz. The sensor instruments may be stand-alone devices that are water resistant, and battery powered. The sensor instruments may be integrated with vehicles, buildings, structures, or objects. The sensor instruments may be attached to a flying or ground-based drone. The triangulation data may be three a dimensional location. The triangulation data may be given as x, y, and z coordinates or latitude and longitude with a depth from the surface. The predictions may include at least a type of the natural resources and location of the natural resources in three dimensions. The report may be a keyhole markup language file. The report may include a list of natural resources and a map showing the location of the natural resources. The different types of natural resources may be identified by a label, symbol, color, and/or identifier on a map, list, file, or application. The different types of natural resources may be displayed in a file or application in which a map of the exploration area may be rotated, zoomed in, filtered for the different natural resources, or otherwise manipulated to view and communicate the predictions. The sensor measurements may be within a range of 1 microhertz to 100 microhertz. The sensor instruments may be buried in ground, set on a surface, or mounted to a secure fixture. The sensor instruments may include a high-definition accelerometer that is vibrationally dampened within the sensor instruments. The sensor measurements may be digitized and have an FFT performed by the sensor instruments or an external device. The sensor instruments may include a battery for powering electrical components and a removable memory. The predictions may be tokenized in one or more blockchain tokens for utilization, transactions, or monetization. The sensor instruments may be waterproof, weather proof, and animal proof. The sensor instruments may have a power switch for turning on the electrical components of the sensor system. The sensor instruments may gather a GPS location when first turned on or periodically. The sensor instruments may include a reset switch for clearing all of the data stored in a memory of the sensor instruments. The sensor measurements may be calibrated utilizing the characteristics of water underground. The sensor measurements may be analyzed to determine an amount of water and water flow rates associated with a target area.

Another embodiment provides a sensor system. The sensor system includes a battery powering electronic components of the sensor system. The sensor system includes a power switch for activating and deactivating the electrical components of the sensor system. The sensor system includes one or more accelerometers capturing sensor measurements associated with a target area. The sensor measurements are within a range of 1 microhertz to 100 microhertz received for the target area. The sensor system includes an analog-to-digital converter converting the sensor measurements to data. The sensor system includes a memory storing the data for analysis. The electrical components of the sensor system are enclosed in a waterproof housing.

In alternative embodiments the sensor system may perform measurements within the target area for greater than two weeks. The sensor system may perform measurements between two to four weeks. The sensor system may be one of at least four sensor systems performing measurements for the target area. The sensor system includes one or more filters in communication with the analog-to-digital converter (ADC) for truncating the data above 0.01 Hz to cut off earth frequencies and moon frequencies.

Another embodiment provides a system for measuring natural resources in an exploration area. The system includes one or more sensor systems measuring signals as sensor measurements for an exploration area to detect the natural resources, the one or more sensor systems include at least a high-definition accelerometer for performing the sensor measurements. The system includes a computing device that receives the sensor measurements from the one or more sensor systems. The computing device analyzes the sensor measurements to generate data and generates one or more predictions regarding at least a type and location of the natural resources of the exploration area utilizing the data.

In alternative embodiments, the computing device may execute an algorithm to perform an FFT of the data and a generate a location for the one or more predictions. The system may include a database in communication with the computing device to securely store the sensor measurements. The database may also store the predictions. The predictions may be saved as a list, KML file, or application. The one or more sensor systems may be at least four sensor systems. The one or more sensor systems each include a transceiver for communicating directly or indirectly with the computing device.

The illustrative embodiments provide a system and method for finding natural resources utilizing gravitational signals. Locations for one or more sensor systems are determined at an exploration area. The one or more sensor systems are activated. Sensor measurements are performed for gravitational signals at the exploration area utilizing the one or more sensor systems. The sensor measurements captured by the one or more sensor systems utilizing the gravitational signals are compiled.

In alternative embodiments, the locations may be determined automatically in response to characteristics of the exploration area. The characteristics may include the size, shape, and structures of the exploration area. The one or more sensor systems may be positioned level at the locations. The one or more sensor systems may be buried, positioned on ground, or positioned above ground. The one or more sensor systems may not require a physical connection to the ground or earth. The method may further include analyzing the sensor measurements and generating the one or more predictions regarding the natural resources within the exploration area utilizing the sensor measurements that have been analyzed. Analysis of the sensor measurements may include utilizing a complex Yukawa potential for incoming waves and outgoing waves. The one or more predictions may include at least a location of the natural resources in three dimensions. The one or more predictions may include at least a location, size, and shape of the natural resources. The sensor measurements may be taken for at least two weeks. These sensor measurements may be taken at 1 Hz. The sensor measurements may be transmitted from the one or more sensor systems to a central system and the one or more predictions regarding natural resources of the exploration area may be generated utilizing the sensor measurements. These sensor measurements compiled by the one or more sensor systems may be saved. The one or more sensor systems may be positioned at the exploration area and the locations of the one or more sensor systems may be recorded. The one or more sensor systems may be buried in ground or mounted to a secure fixture. Triangulation of these sensor measurements may be performed to generate one or more predictions of the natural resources. These sensor measurements may be performed by one or more accelerometers that are mounted to a vibration dampener. A fast Fourier transform of the sensor measurements may be performed to generate one or more projections. The fast Fourier transform of the sensor measurements may be performed with a radix-2 or radix-4. The analysis of the sensor measurements may be performed at the exploration area. The analysis of these sensor measurements may be performed remotely. The gravitational signals may represent gravitational waves. The gravitational signals of the earth gravitational signal may correspond to approximately 11 micro hertz. The one or more sensor systems may include solar cells for charging a battery of the one or more sensor systems at the exploration area. The sensor measurements may be taken at the exploration area from ten days to one month.

Another embodiment provides a system and method for performing geological exploration for natural resources. The system includes one or more gravitational sensor systems measuring gravitational signals as sensor measurements for an exploration area to detect natural resources. The system further includes a computing device that receives the sensor measurements from the one or more gravitational sensors. The computing device analyzes the sensor measurements and generates one or more predictions regarding the natural resources of the exploration area utilizing the sensor measurements that have been analyzed.

In alternative embodiments the system may include a database in communication with the computing device configured to store the sensor measurements. The one or more gravitational sensor systems may include one or more accelerometers for performing the sensor measurements in high resolution and a memory for storing the sensor measurements. The one or more accelerometers may be mounted to a vibrational dampener. The one or more gravitational sensor systems include a transceiver for communicating directly or indirectly with the computing device. The computing device may communicate the one or more predictions including at least a map of the natural resources showing at least one or more locations in three dimensions. The one or more predictions may include a size and shape of the natural resources.

The illustrative embodiments provide an enhanced system, method, network, platform, and devices for identifying and locating natural resources. The natural resources may include elements, minerals, boundaries (e.g., bedrock, layers, etc.) and other compositions in ground, a body of a user or animal, in water (e.g., pipe, reservoir, river, lake, aquifer, etc.). Gravitational resonances are measured by a sensor system including an accelerometer. The gravitational resonances are slow moving waves or signals that change over time. From the FFT of these signals, an amplitude is determined based on the frequency which determined from Equation 26.

The bedrock density may be determined (or assumed if known) by working backwards from the known water frequency. After knowing the frequency and finding the amplitude, this information is utilized to triangulate between other measurements of the same frequency (e.g., minerals) and then locate the depth and the ore grade (or gallons per minute if water) of the material. Each mineral density corresponds a unique frequency and the amount of time that data is samples determines the frequency resolution of the density measurements. The longer the time measurements are taken, the higher the resolution between two or more densities. No other material with a different density will interfere with the measurement of a material of a given density as those measurements will fall in different bins of the frequency spectrum.

The illustrative embodiments provide an enhanced system, method, network, platform, and devices for identifying and locating natural resources. The natural resources may include elements, minerals, boundaries (e.g., bedrock, layers, etc.) and other compositions in ground, a body of a user or animal, in water (e.g., pipe, reservoir, river, lake, aquifer, etc.). Gravitational resonances are measured by a sensor system including an accelerometer. The gravitational resonances are slow moving waves or signals that change over time. From the FFT of these signals, an amplitude is determined based on the frequency which determined from:

$${Mineral}_{Frequency} = 1.1 \times {10}^{- 5} Hz * \sqrt{\frac{Density\_bedrock}{density\_mineral}}$$

The bedrock density may be determined (or assumed if known) by working backwards from the known water frequency. After knowing the frequency and finding the amplitude, this information is utilized to triangulate between other measurements of the same frequency (e.g., minerals) and then locate the depth and the ore grade (or gallons per minute if water) of the material. Each mineral density corresponds a unique frequency and the amount of time that data is samples determines the frequency resolution of the density measurements. The longer the time measurements are taken, the higher the resolution between two or more densities. No other material with a different density will interfere with the measurement of a material of a given density as those measurements will fall in different bins of the frequency spectrum.

In another embodiment, the sensor system may perform measurements of a human or animal body. The measurements may be analyzed to determine water within the human or animal body. The measurements may determine materials and contaminants within the human or animal body. An FFT of the measurements may be utilized to perform the determinations. The sensor system may be integrated with a bed, chair, ceiling, or fixture above the human or animal body. The determinations may indicate concentrations of water, materials, or contaminants in the human or animal body.

### BRIEF DESCRIPTION OF THE DRAWINGS

Illustrative embodiments of the present invention are described in detail below with reference to the attached drawing figures, which are incorporated by reference herein and wherein:

FIG. 1 is a pictorial representation of an exploration environment in accordance with an illustrative embodiment;

FIG. 2 is a pictorial representation of gravitational sensors operating in accordance with an illustrative embodiment;

FIG. 3 is a block diagram of a gravitational sensor in accordance with an illustrative embodiment;

FIG. 4 is a pictorial representation of a gravitational sensor system in accordance with an illustrative embodiment;

FIG. 5 is a flowchart of a process for using gravitational waves to detect natural resources in accordance with an illustrative embodiment;

FIG. 6 is a flowchart of a process for processing gravitational signals in accordance with an illustrative embodiment;

FIG. 7 is a flowchart of a process for utilizing sensor systems in accordance with an illustrative embodiment;

FIG. 8 is a pictorial representation of a prediction in accordance with an illustrative embodiment;

FIG. 9 is a graph illustrating interactions between potentials moving in opposite directions;

FIG. 10 is a graph illustrating interactions between potentials moving in opposite directions in accordance with illustrative embodiments;

FIGS. 11-13 show captured data in accordance with illustrative embodiments;

FIG. 14 is a graphical version of captured data as a continuous wave form in accordance with an illustrative embodiment;

FIGS. 15-17 show captured data in accordance with illustrative embodiments;

FIG. 18 is a map of measured data in accordance with an illustrative embodiments;

FIG. 19 is a flowchart of a process for processing amplitude in accordance with an illustrative embodiment;

FIG. 20 is a pictorial representation of a sensor system for measuring water composition in accordance with an illustrative embodiment;

FIG. 21 is a pictorial representation of a sensor system 2100 for measuring water and material composition of a user 2102 in accordance with an illustrative embodiment; and

FIG. 22 shows a table of exemplary material data in accordance with an illustrative embodiment.

### DETAILED DESCRIPTION OF THE DRAWINGS

The illustrative embodiments provide a system and method for detecting and processing gravitational waves and/or signals. In one example, the gravitational waves may be utilized to perform geological exploration. In another example, the gravitational waves may be utilized for detecting Near-Earth Objects (NEO). In another example, the gravitational waves may be utilized to determine the composition or make up of materials or liquids, such as determining the composition of water (e.g., minerals, metal ions, additives, contaminants, etc.). The gravitational waves may be detected utilizing a system that is extremely inexpensive, durable, mobile, and user friendly. As a result, new uses of the gravitational waves may be implemented.

Another embodiment provides a system and method for measuring gravitational waves from the earth using a system that samples the waves using an accelerometer system. For example, the accelerometer may sample the once per second for a minimum of two weeks. In another applications, the accelerometers may perform samples much more frequently for shorter time periods. The accelerometer may be level with the earth or may not require leveling. The Fast Fourier Transform (FFT) of the resulting data (e.g., 1 sample per second) reveals a low frequency signal at approximately 11 microhertz (μHz) which has a high signal-to-noise ratio that is consistent with theoretical calculations of the gravitational wave frequency of the earth. The illustrative embodiments may be focused on measurements within 1 microhertz to 100 microhertz. The illustrative embodiments also provide a method of using variations in this signal, due to the change in density of materials below the surface of the earth, to determine materials and location of the materials. The density of the materials affects the frequency of the gravitational wave signal measured at the surface of the earth to perform the measurements. The various embodiments allow predictions to be made regarding material composition, locations of the materials, and underground mapping of materials.

The illustrative embodiments may be utilized to determine the elemental composition and coordinates of nearby natural resources (e.g., metal ores, hydrocarbons, water, etc.). A combination of different metals will result in a composite frequency shift that may be predicted mathematically based on the relative densities and volumes of combined natural resources. Various measurements and verifying results have been performed near known natural resource deposits (i.e., Bingham Copper Mine, Utah, Silver Reef Mine in St. George, Utah, etc.).

The various embodiments described in the Figures and the associated embodiments, variations, and description may be applied to any of the other Figures and corresponding description in any number combinations. The described embodiments may be implemented and combined in various applications across the Figures and description regardless of restrictions, limitations, or inhibitions that may be artificially or subsequently placed the embodiments.

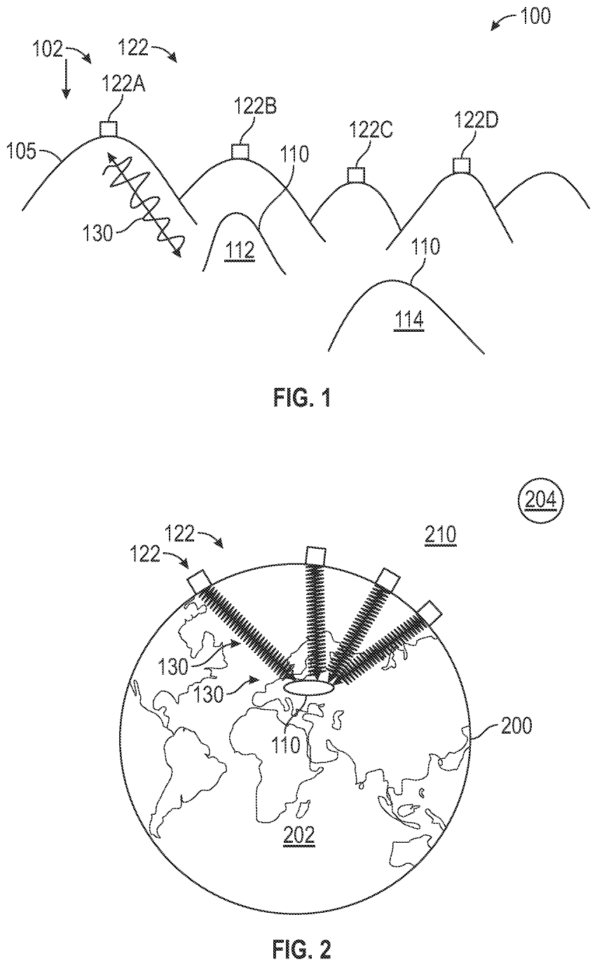

FIG. 1 is a pictorial representation of an exploration environment 100 in accordance with an illustrative embodiment. The exploration environment 100 represents terrain 105, landscape, or other external features of the earth (or other planetary body). The terrain 105 may include mountains, hills, valleys, caves, plains, rivers, lakes, oceans or other features defining the surface of the earth. In one embodiment, the exploration environment 100 may represent an area or location that is being scouted, evaluated, or analyzed for potential natural resources 110, such as deposits, 112, 114.

The exploration environment 100 may be explored utilizing gravitational sensors 122A, 122B, 122C, 122D (altogether gravitational sensors 122). The gravitational sensors 122 may also be referred to as gravitational sensor systems or sensor systems. The gravitational sensors 122 may represent a single gravitational sensor that is moved between different locations and positions within the exploration environment 100 or multiple gravitational sensors 122 positioned in distinct locations over a different time period. For example, the gravitational sensors 122 may represent four or more sensor systems performing measurements. The measurements of the gravitational sensors 122 may be performed simultaneously, concurrently, or sequentially depending on the availability of the sensor systems 120 and the needs of those performing geological exploration.

The gravitational sensors 122 may be buried, set/positioned on the surface, mounted to objects (above or below ground), or otherwise positioned within the exploration environment 100. In some instances, where the target is on the surface of the terrain 105, the gravitational sensors 122 may be mounted in the air utilizing poles, tripods, trees, supports, balloons, or so forth. In one embodiment, the gravitational sensors 122 may be positioned around the perimeter of a desired exploration area 102 of the exploration environment 100. The gravitational sensors 122 may also include a marker for placing and retrieving the gravitational sensors in snow, brushy terrain, changing terrain, and so forth. In one embodiment, the marker may extend vertically from the terrain 105. The marker may also be a plate, paint, balloon, or other marker. The gravitational sensors 122 may also be placed directly above the terrain 105 that shows the most promise in the exploration environment 100 based on known geological information (e.g., seams, surface materials, rivers, creeks, plates, mountains, etc.). In one embodiment, the gravitational sensors 122 may sense/capture and record the gravitational waves 130. In another embodiment, the gravitational sensors 122 may also be configured to perform analysis, processing, or determinations associated with the exploration environment 100 and the natural resources 110.

The gravitational sensors 122 may sense gravitational waves 130 or signals or originating within or traveling through the earth including the exploration environment 100. The gravitational waves 130 may interact with the natural resources 110 thereby changing the gravitational waves 130 (e.g., amplitude, frequency, phase, etc.). The gravitational waves 130 and changes in the gravitational waves 130 may be detected by the gravitational sensors 122. The changes in the gravitational waves may be utilized to generate determinations, identify natural resources, quantities or amounts of natural resources, natural resource composition, and location.

FIG. 2 is a pictorial representation of gravitational sensors operating in accordance with an illustrative embodiment. FIG. 2 shows an exploration environment 200 that provides additional details although not shown to scale. For example, the size, shape, and proximity of earth 202 and moon 204 are not realistic or to scale. As previously described, the gravitational sensors 122 may sense the gravitational waves 130 to detect the presence of the natural resources 110. The gravitational waves 130 are affected by the measurement of the gravitational field of the earth 202 and the moon 204. The sensor measurements may be performed simultaneously, concurrently, and/or sequentially utilizing the gravitational sensors 122. The gravitational sensors 122 may represent a standalone system utilized to perform measurements. For example, the gravitational sensors 122 may also be referred to as a sensor system and may be part of an overall platform 210. The gravitational sensors 122 may also be integrated with other equipment, devices, vehicles (e.g., trucks, excavators, processing equipment, generators, drones, etc.), or systems that are fixed, temporary, or mobile.

As previously noted, the natural resources 110 may represent any number of minerals, hydrocarbons, elements, or other compounds (e.g., water, coal, brine, etc.). The gravitational sensors 122 may utilize highly sensitive accelerometers, such as high-resolution MEMS accelerometers that are vibrationally dampened across low frequencies. As is expected, the portion of the gravitational waves 130 contributed to the moon 204 varies as the relative distance between the earth and moon changes slightly through the lunar cycle. The relative positioning and distance of the sun, earth 202, and moon 204 may affect the gravitational waves 130 and are therefore compensated for.

It is well documented that mechanical and electromagnetic waves diffract as they pass through materials of different densities and structure. The presence of the natural resources 110 affects the amplitude (i.e., generally decreases) and shifts the frequency of the gravitational waves 130 sets of the different gravitational waves 130 detected by the gravitational sensors 122.

In one embodiment, the gravitational sensors 122 may each be stand-alone devices that capture applicable measurements associated with their respective locations within the exploration environment 200. The gravitational sensors 122 may be positioned to gather measurements and retrieved to download/receive the measurements, perform processing to identify natural resources and associated locations, and generate analytical information, reports, models, and other details. The distance between the gravitational sensors 122 may be determined based on the resolution and fidelity required for the exploration environment 200. For example, for small features, such as a small vein of gold, it may be best to have the gravitational sensors 122 one hundred to two hundred feet apart. When looking at large features the gravitational sensors 122 may be positioned approximately eight hundred feet apart. It is possible to examine an exploration area utilizing 4-100+ gravitational sensors 122. The further the distance between the gravitational sensors 122 the less shallow features may be measured and the more deeper features are measured.

In another embodiment, the gravitational sensors 122 may communicate directly or indirectly with a central device (e.g., data aggregator, server, vehicle, etc.), each other, or other devices within the exploration environment 200. For example, the gravitational sensors 122 may communicate with each other or a central device of the platform 210 utilizing a cellular, satellite, radio frequency, or other wireless signal. In other examples, wired connections, such as fiber optics, cable, Ethernet, or other wired connections may be utilized. In one embodiment, the gravitational sensors 122 may communicate through a mesh network (e.g., controlling device). One or more of the gravitational sensors 122 (e.g., a control sensor, control unit, or master unit) may capture and store data from all of the gravitational sensors 122. The controlling sensor or device may be equipped with a transceiver or transmitter for communicating the captured gravitational waves 130 in real-time, over a time period, or as otherwise specified or required for the exploration environment 200.

The platform 210 may utilize the data from the gravitational sensors 122 to map the specific, detailed, or general size, shape, and location of the natural resources 110 within the exploration environment 200. The platform 210 may utilize software to process the gravitational waves 130 to provide the detailed visual (e.g., three-dimensional map, two-dimensional map, etc.), textual/numeric, and/or audio information regarding the natural resources 110. For example, a map or visual representation of the exploration environment 200 and the natural resources 110 with associated data and text may be generated. The platform 210 may process the data from the gravitational sensors 122 including the gravitational waves 130 proximate the location of the sensors 122 or remotely.

The gravitational sensors 122 measure and capture the gravitational waves 130 over a specified time period or as available or required to capture sufficient data to provide information about the natural resources 110. The natural resources 110 may be spread, disbursed, or distributed in any number of concentrated, random, erratic, sparse, sporadic, or other distributions or patterns within the exploration environment 200 as occurs in nature and based on natural processes. For example, minerals or ores making up the natural resources 110 may be distributed in seams, faults, crevices, plains, riverbeds, plates, pockets, or other geographic features, whether aboveground or below ground, within the exploration environment 200. The gravitational sensors 122 and the platform 210 may process information together to provide the geographic information, mapping, and other data.

In one embodiment, the gravitational sensors 122 may be incorporated in movable or mobile bodies, housings, or devices. For example, sensors 122 may be incorporated in flying or ground-based drones that may be utilized to put the gravitational sensors 122 into desired locations of the exploration environment 200. One or more cameras and location systems (e.g., GPS, triangulation, etc.) may be utilized to drive or fly the gravitational sensors 122 to the preferred locations within the exploration environment 200. The gravitation sensors 122 may also be incorporated into vehicles. For example, the gravitational sensors 122 may be attached to, integrated with, or otherwise associated with construction or excavation vehicles to perform measurements while the vehicles are not in use. The gravitational sensors 122 may also be integrated with or attached to markers, signs (e.g., electronic, non-electronic, etc.), temporary buildings, fixtures, or so forth.

The gravitational sensors 122 may be powered by reusable or one time use batteries. The gravitational sensors 122 may also be equipped with solar cells, miniature wind turbines, fuel cells, or other power generation devices for extended use and relocation between different exploration environments without the need to be recharged, maintained, or otherwise serviced or maintained between exploration projects or j obs.

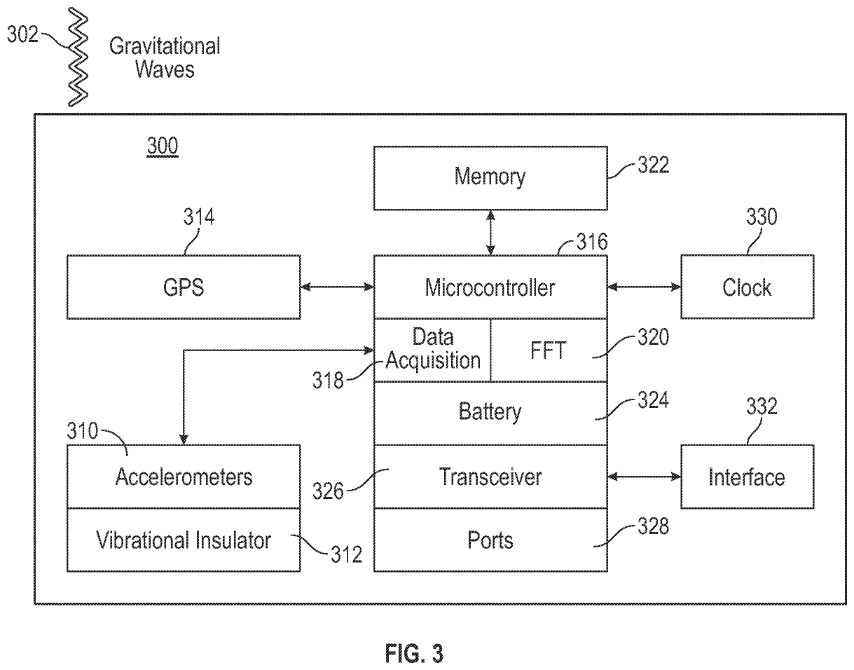

FIG. 3 is a block diagram of a gravitational sensor system 300 in accordance with an illustrative embodiment. The gravitational sensor system 300 is one embodiment of the gravitational sensors 122 of FIGS. 1 and 2. The gravitational sensor system 300 is configured to detect and measure gravitational waves 302. The gravitational waves 302 may also be referred to herein as gravitational signals, earth signals, or natural signals which may include earth and moon waves/signals/frequencies. The gravitational sensor system 300 may be custom built for specified environmental areas or may be mass produced for utilization in numerous areas.

In one embodiment, the gravitational sensor system 300 may include a housing, accelerometers 310, vibrational insulator 312, a global positioning system (GPS) 314, a microcontroller 316, data acquisition 318, FFT 320, a memory 322, a battery 324, a transceiver 326, ports 328, a clock 330, and an interface 332.

Different variations, configurations, models, and/or configurations of the gravitational sensor system 300 may be implemented based on the exploration area, applicable natural resources, time of year, environment, network availability, and so forth. For example, gravitational sensor systems 300 without an available cellular network may be configured with a transceiver 326 that implements satellite communications. In another example, a gravitational sensor system 300 in a high traffic area, such as parks, recreation areas, or popular areas may be miniaturized with a camouflaged housing to prevent drying unwanted attention or theft of the gravitational sensor system 300. As previously noted, temporary or request-based markers (e.g., pop-up flag mechanism, flares, lights, speakers, etc.) may be utilized to ensure that the gravitational sensor system 300 is not lost during use.

Some models of the gravitational sensor system 300 may have a memory 322 and battery 324 with added capacity for taking measurements over longer time periods (e.g., one month, six weeks, etc.). In some embodiments, the gravitational sensor system 300 may perform all of the analysis and processing regarding any detected natural resources, such as determining one or more types of natural resources, a location, size, shape/configuration, and other applicable information. The gravitational sensor system 300 may also be integrated with other equipment, devices, systems, vehicles, or so forth. For example, the gravitational sensor system 300 may be integrated with one or more excavators of a mining operation. As a result, readings may be taken at night or on weekends when the excavators are not in use. The battery or other components of the excavators may be utilized. The gravitational sensor systems 300 may be integrated with alternating current or direct current power systems associated with buildings, vehicles, systems, equipment, objects, or so forth.

The housing may be waterproof/water resistant, dirt proof, and otherwise sealed against environmental factors, such as rain, wind, sun, animals, bugs, and prolonged outdoor exposure. In some embodiments, the gravitational sensor system 300 may be buried to enhance the interface with the earth and corresponding signals, protection from the elements and outside resources, and to prevent unwanted attention or stealing of the gravitational sensor system 300. The housing may be a metal, plastic, polymer, or other shell that insulates and protects the various components of the gravitational sensor system 300. In one embodiment, the housing may have multiple portions that open or attach utilizing screws, bolts, tabs, buckles, an interference fit, or so forth. For example, the housing may have a clam shell configuration that hingedly opens and closes to access and protect the internal components. The housing 308 may include one or more portions, such as a bottom, sides, and a lid/cover.

The housing may incorporate insulation or insulators that protect the gravitational sensor system 300 from extreme weather conditions including cold and heat. The gravitational sensor system 300 may be ideally utilized in the winter when digging and excavating are not possible to identify and locate different materials so that in shorter working seasons (e.g., Alaska, Canada, Norway, Russia, etc.) that excavation efforts are maximized based on the identified information. Any number of insulators or insulation types may be utilized (e.g., ABS, acrylics, ceramics, fiberglass, Styrofoam, foam, silicone, rubber, PVC, polyurethane, nylon, polyester, polycarbonate, neoprene, or combinations thereof).

The vibrational insulator 312 insulates all or portions of the gravitational sensor system 300 from outside vibrations, noises, movements, and so forth. In one embodiment, the vibrational insulator 312 insulates the accelerometers 310 utilizing dampening materials, suspension, or so forth. For example, the vibrational insulator 312 may include rubber, rubber composites, sorbothane, active dampeners, or so forth. The vibrational insulators 312 may include pads upon which the accelerometers 310 are mounted. The vibrational insulator 312 may also be cover all or portions of the exterior and/or interior of the housing.

In one embodiment, many of the components of the gravitational sensor system 300 may be incorporated on a single chip, circuit, or other platform. As a result, the gravitational sensor system 300 may be miniaturized for utilization with small drones (e.g., flying, driving, etc.), micro sensor systems, vehicles, fixtures (e.g., signs, markers, fences, buildings, posts, etc.), or other devices.

The battery 324 is a power storage device configured to power the gravitational sensor system 300. For example, the battery 324 may be rechargeable battery, such as a lithium-ion, nickel cadmium, nickel-metal hydride, and other batteries. The battery 324 may also represent the power system of the gravitational sensor system 300 that may include plugs, boards, interfaces, transformers, amplifiers, converters, or so forth. In other embodiments, the battery 324 may represent a fuel cell, thermal electric generator, inductive power system, solar cell, ultra-capacitor, or other existing or developing power storage technologies. As a result, the use of gravitational sensor system 300 may be prolonged. The gravitational sensor system 300 may also be configured to tie into existing power systems (e.g., buildings, houses, oil/gas equipment, vehicles, generators, etc.) utilizing ports, transformers, adapters, interfaces, pins, contacts, inductive interfaces, converters, or so forth. In another embodiment, the gravitational sensor system 300 may include an alternative or back up power source or system, such as a solar cell, fuel cell, or so forth. For example, a solar cell may be utilized to power the various components and circuits of the gravitational sensor system 300 and/or to recharge the battery 324.

The microcontroller 316 is a compact micro-computer manufactured to control the functions of embedded systems, such as those of the gravitational sensor system 300. For example, the microcontroller 316 may be a miniature computer on a single metal-oxide-semiconductor (MOS) integrated circuit (IC) chip. The microcontroller 316 may include one or more central processing units (CPUs), wireless processors, or other processing devices and may include a memory (e.g., RAM, NOR flash, ROM, etc.) and peripherals. The microcontroller 316 may include or alternatively be substituted for a processor or other logic engine. The microcontroller 316 may govern the operations of the gravitational sensor system 300 to capture the measurements.

In one embodiment, a processor or a logic engine is circuitry or logic enabled to control execution of a set of instructions. The processor may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, performing mathematical calculations, and performing other related tasks. The logic engine may represent the logic that controls the operation and functionality of the gravitational sensor system 300. The logic engine may include circuitry, chips, and other digital/analog logic. The logic engine may also include programs, scripts, and instructions that may be implemented or executed to operate the logic engine. The logic engine may represent hardware, software, or any combination thereof.

The clock 330 may provide precise time measurements to the various components of the gravitational sensor system 300. In other embodiments, the clock 330 may be integrated with other devices, such as the GPS 314 or microcontroller 316.

The accelerometers 310 perform high resolution measurements of the exploration area. In one embodiment, the accelerometers 310 may represent one or more high-resolution MEM accelerometers. The MEMS accelerometer may be mounted to a fixture or printed circuit board for stability (e.g., positioning, vibrational dampening, longevity as moved, dropped, etc.), functionality, and connections to other devices. The MEMS accelerometer used may represent any number of accelerometers, such as an accelerometer with a 1.5 g range, 5V DC supply and a sensitivity of 1.33V/g or a range of 2 g and a sensitivity of 2 V/g.

The data acquisition 318 hardware is configured to receive the signals from the accelerometers 310. In one embodiment, the data acquisition 318 hardware may represent an analog-to-digital converter that converts the measurements made by the accelerometer into digital measurements. Analog-to-digital conversion may be utilized to convert the analog gravitational signals into quantifiable data that may be more easily processed, analyzed, and stored. Processing may be performed separate from the gravitational sensor system 300 or may be performed on board.

The FFT 320 may perform Fast Fourier Transforms (FFT). In one embodiment, a chip may perform FFTs as needed on data received from the data acquisition 318 hardware. In another embodiment, the FFT 320 may be integrated with the microcontroller 316 or processor to perform as many Fast Fourier Transforms as may be necessary.

In another embodiment, the gravitational sensor system 300 may perform a measurement utilizing the global positioning system 314 to get an accurate measurement of the gravitational sensor system 300. In one embodiment, the GPS 314 may only perform measurements when turned on, once a day, once an hour, or as otherwise specified because of the low likelihood that the gravitational sensor system 300 will move during utilization. The measurements may be saved in the memory 322 and may also be communicated through the transceiver 326 (if included). The electronic and hardware configuration of the gravitational sensor system may also be such that the data acquisition 318 directly connected to the accelerometers 310 with the digitized data being saved to the memory 322 for analysis and processing outside the gravitational sensor system 300 with the battery 324 powering the electric components of the gravitational sensor system 300 as long as the device is being run or until retrieved and turned off (e.g., utilizing a power switch of the interface 332). An SD card holder and charging connection for the battery 324 may also be integrated with the simplified version of the gravitational sensor system 300. The various components may be mounted to a printed circuit board to integrate and protect the various items. In other embodiments, the various components may be built into a single chip, circuit, or board that may be miniatured for easier use, disposable usage, integration (e.g., vehicles, drones, equipment, etc.), or so forth.

The memory 322 is a hardware element, device, or recording media configured to store data or instructions for subsequent retrieval or access at a later time. The memory 322 may represent static or dynamic memory. The memory 322 may include a secure digital (SD) card, hard disk, random access memory, cache, removable media drive, mass storage, or configuration suitable as storage for data, instructions, and information. In one embodiment, the memory 322 may be integrated with the microcontroller 316 or the processor logic engine. The memory 322 may use any type of volatile or non-volatile storage techniques and mediums. The memory 322 may store information related to the client, location, position/orientation, exploration area, other gravitational sensor systems (e.g., proximity, location, communications protocols, etc.), calibration information, lunar cycles, security information profiles, and so forth. In one embodiment, the memory 322 may display or communicate instructions, programs, drivers, or an operating system for controlling the gravitational sensor system 300, analyzing and processing gravitational waves/signals, and otherwise performing the processes herein described.

The memory 322 may also store pin numbers, passwords, keys, encryption information, network access information, and other information for securely communicating with other gravitational sensor systems, networks, wireless devices, users, and so forth. In one embodiment, the memory 322 may also represent any number of memory cards (e.g., secure digital (SD) cards, mini SD cards, USB drives, etc.). The memory 322 may be positioned or connected to a SD card holder, port, interface, or other device.

The transceiver 326 is a component comprising both a transmitter and receiver which may be combined and share common circuitry on a single housing. The transceiver 326 may communicate utilizing low frequency (LF), high frequency (HF), or ultra-high frequency (UHF), radio frequency identification (RFID), near field communications (NFC), near-field magnetic induction (NFMI) communication, Bluetooth, Wi-Fi, ZigBee, Ant+, near field communications, wireless USB, infrared, mobile body area networks, ultra-wideband communications, cellular (e.g., 4G, 5G, 6G, PCS, GSM, etc.), satellite (e.g., StarLink®, Hughes Net®, etc.), infrared, or other suitable radio frequency standards, networks, protocols, or communications whether existing or being developed. For example, the transceiver 326 may coordinate communications and actions between the gravitational sensor systems, cloud system, servers, stand-alone devices, and/or other devices utilizing radio frequency communications. The transceiver 326 may also be a hybrid transceiver that supports a number of different communications. The transceiver 326 may also detect time receipt differentials, amplitudes, and other information to calculate/infer distance between the gravitational sensor system 300 and other devices. The transceiver 326 may also represent one or more separate or stand-alone receivers and/or transmitters.

The components of the gravitational sensor system 300 may be electrically connected utilizing any number of wires, contact points, leads, busses, chips, wireless interfaces, or so forth. In addition, the gravitational sensor system 300 may include any number of computing and communications components, devices or elements which may include busses, motherboards, circuits, chips, sensors, ports, interfaces, cards, converters, adapters, connections, transceivers, displays, antennas, and other similar components.

The gravitational sensor system 300 may also be configured with other sensors to take any number of measurements regarding the exploration environment, users, or so forth. For example, the sensors may include accelerometers, gyroscopes, time-of-flight sensors, ambient light sensors, infrared, optical, temperature, barometer, temperature, barometric, and other applicable sensors.

The ports 328 are a hardware interface of the gravitational sensor system 300 for connecting and communicating with computing devices (e.g., desktops, laptops, tablets, gaming devices, etc.), wireless devices or other electrical components, devices, or systems. In one embodiment, the ports 328 may include power, communications, wireless, and other ports and interfaces. For example, syncing and charging may be performed by an external device through the ports 328. In another example, software or firmware updates may be performed through the ports 328 to control, tune, or otherwise adjust the performance of the gravitational sensor system 300 (i.e., microcontroller instructions, accelerometer settings, etc.). The ports 328 may also allow the gravitational sensor system 300 to function and communicate with other devices, systems, equipment, or components.

The ports 328 may include any number of pins, arms, or connectors for electrically interfacing with the contacts or other interface components of external devices or other charging or synchronization devices. For example, the ports 328 may include USB, HDMI, Ethernet, Firewire, micro-USB, mini-USB, USB-C, and AC/DC ports and interfaces. In one embodiment, the ports 328 may include a magnetic interface that automatically couples to contacts or an interface of the gravitational sensor system 300 for powering the components of the gravitational sensor system 300, recharging the battery 324, communications, or interacting with the microcontroller 316 or the memory 322. A sealed interface or cover may be utilized to further protect the ports 328. In another embodiment, the ports 328 may include a wireless induction device for recharging or communicating with the components of the gravitational sensor system 300.

In other embodiments, the gravitational sensor system 300 may include the interface 332. In one embodiment, the interface 332 may include a power switch for powering on and off the gravitational sensor system 300. The interface 332 may also include a button for resetting the data stored by the memory 322 of the gravitational sensor system 300. The user interface may be a hardware and/or software interface for receiving commands, instructions, or input through buttons, dials, switches, touch screens, voice commands, or so forth. For example, the interface 332 may receive and process the touch (haptics) of the user, voice commands, or predefined motions. One or more buttons, dials, switches, or components of the interface 332 may also be utilized to activate different modes, sensor configurations, or provide other applicable information. The interface 332 may also include a touch screen (including a fingerprint scanner), one or more cameras or image sensors, microphones, speakers, and so forth. Although not shown, the interface 332 may also include one or more speakers and speaker components (e.g., signal generators, amplifiers, drivers, and other circuitry) configured to generate sounds waves at distinct frequency ranges (e.g., bass, woofer, tweeter, midrange, etc.) or to vibrate at specified frequencies to be perceived by the user as sound waves. For example, the speakers of the interface 332 may play sounds or alerts when the user begins looking for the gravitational sensor system 300 to retrieve it after taking measurements.

The interface 332 may be utilized to control the other functions of the gravitational sensor system 300. As noted, the interface 332 may include the hardware buttons, one or more touch sensitive buttons or portions, a miniature screen or display, or other input/output components. The interface 332 may be controlled by the user or based on commands received from an associated wireless device, or other authorized devices (e.g., communications received by the transceiver and communicated to the interface 332. The user may also implement diagnostics or recalibrations utilizing the interface 332.

The interface 332 may also include one or more microphones, speakers, or cameras. The microphone(s) may represent any number microphone types utilized to sense a user's voice, external noise, and so forth. The microphones may be utilized to receive user input as well as detect the presence of the user. For example, the speaker and microphones may be utilized to confirm that the gravitational sensor system 300 is powered on and performing measurements. The microphones and cameras may also be utilized to secure the gravitational sensor system 300 and provide any images, recordings, or other content if the gravitational sensor system 300 is accessed or disturbed by an unauthorized party (e.g., thief, animals, saboteur, etc.).

The interface 332 may include any number and type of devices for receiving user input and providing information to the user. In one example, the device includes a tactile interface, an audio interface, and a visual interface. The tactile interface includes features that receive and transmit via touch. For example, as noted above, the interface 332 may include one or more buttons to receive user input. In one example, a single button of the gravitational sensor system 300 may identify and authorize the user utilizing a fingerprint scan as well as recording a time that the user is at an associated location. Another selection of the button may indicate that the user is leaving the associated location. Buttons, switches, or other components on the sensor may also control emergency messages that may be sent based on being pressed or activated.

In one embodiment, the gravitational signals, raw measurements, natural resource predictions (e.g., location, size, shape, depth, etc.), and other secured data of the gravitational sensor system 300 may be encrypted and stored within a secure portion of the memory 322 to prevent unwanted access or hacking. The gravitational sensor system 300 may also store company information identifying the owner, operator, or other parties associated with the gravitational sensor system 300. The gravitational sensor system 300 may be utilized with other devices to form a larger system, platform, network, or array.

In one embodiment, the gravitational sensor system 300 may be a master device that the other gravitational sensor systems communicate with to report data and information. For example, the master gravitational sensor system may include the transceiver 326 for making cellular, satellite, Wi-Fi, or other data communications. The gravitational sensor system 300 may communicate with a hub, wireless device, or tower utilizing a cellular, Wi-Fi, ultra-wide band, or other longer-range connection. For example, a mesh network may be established between sensors, devices, and equipment in a large exploration area where distances are too great for all of the gravitational sensor systems to communicate to a central location. The gravitational sensor system 300 may also communicate utilizing short range communications signals, standards, or protocols (e.g., Bluetooth, Wi-Fi, ZigBee, proprietary signals, etc.).

The gravitational sensor system 300 may also execute an application with settings or conditions for communication, self-configuration, updating, synchronizing, sharing, saving, identifying, calibrating, and utilizing biometric and environmental information as herein described. The alert may be communicated through a text message, in-application message communicated through the user's computer, smart phone, smart watch, smart hub, or other device, audio alert from interface 332, vibration, flashing lights, display, or other system for the gravitational sensor system 300.

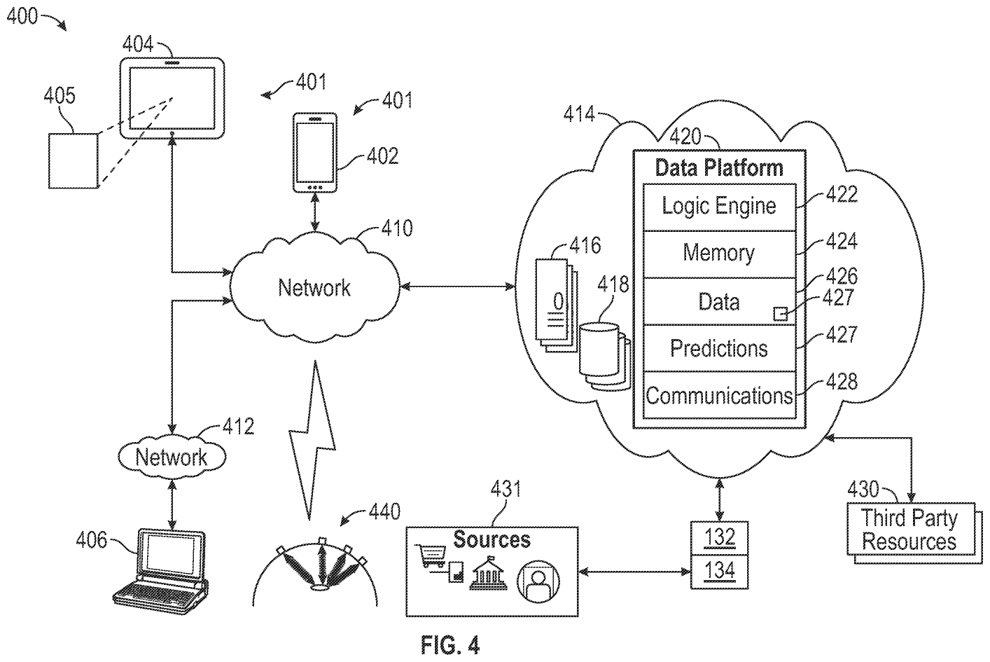

FIG. 4 is a pictorial representation of a system 400 in accordance with an illustrative embodiment. In one embodiment, the system 400 of FIG. 4 may include any number of devices 401, networks, components, software, hardware, and so forth. In one example, the system 400 may include a smart phone 402, a tablet 404 displaying graphical user interface 405, a laptop 406 (altogether devices 401), a network 410, a network 412, a cloud system 414, servers 416, databases 418, a data platform 420 including at least a logic engine 422, a memory 424, data 426, predictions 427, and communications 428. The cloud system 414 may further communicate with sources 431 and third-party resources 430. One or more gravitational sensor systems 440 may receive gravitational waves within an exploration area to make predictions regarding a type, composition/density (e.g., ounces per ton, etc.), location, size, and/or shape of natural resources. The various devices, systems, platforms, and/or components of the system 400 may work alone or in combination. Gravitational sensors systems 440 may communicate with the network 410 or directly with any of the devices 401 or the cloud system 414 (or devices thereof).

Each of the devices, systems, and equipment of the system 400 may include any number of computing and telecommunications components, devices or elements which may include processors, memories, caches, busses, motherboards, chips, traces, wires, pins, circuits, ports, interfaces, cards, converters, adapters, connections, transceivers, displays, antennas, operating systems, kernels, modules, scripts, firmware, sets of instructions, and other similar components and software that are not described herein for purposes of simplicity. The system 400 may also be referred to as a geological exploration platform, platform, gravitational system, sensor system, or so forth.

In one embodiment, the system 400 may be utilized by any number of users, organizations, or providers to aggregate, manage, review, analyze, process, distribute, and/or monetize data 426. The data 426 may include gravitational wave readings, sensor measurements, location or placement data, natural resource prediction data, software, algorithms, equations, scripts, weather data, seismic data, and other forms of data. For example, the data 426 may be utilized to provide specific predictions regarding the natural resources within the exploration area. In one embodiment, the system 400 may utilize any number of secure identifiers (e.g., passwords, pin numbers, certificates, etc.), secure channels, connections, or links, virtual private networks, biometrics, or so forth to upload, manage, and secure the data 426, generate the predictions 427, and perform applicable communications 428.

The devices 401 are representative of multiple devices that may be utilized by businesses, organizations, geologists, experts, administrators, or users, including, but not limited to the devices 401 shown in FIG. 4. The devices 401 utilize any number of applications, browsers, gateways, bridges, signals, or interfaces to communicate with the cloud system 414, platform 420, gravitational sensor systems 440, and/or associated components. The devices 401 may include any number of Internet of Things (IoT) devices.

The data 426 may include a number of different data types. For example, the data 426 may also include geographic data, property data, client data, environmental data, and so forth. The data 426 may be received or captured by the gravitational sensor systems 440 or other components, systems, equipment, sensors, or devices. The user may represent service providers, experts, geologists, individuals, families, groups, entities, businesses, aggregations, or other parties.

The wireless device 402, tablet 404, and laptop 406 are examples of common devices 401 that may be utilized to capture, receive, and manage data 426, generate predictions 427, and perform communications 428. For example, the various devices may capture data relevant to the exploration area, gravitational sensor systems 440, and other devices of the system 400. Other examples of devices 401 may include e-readers, cameras, video cameras, electronic tags, audio systems, gaming devices, vehicle systems, kiosks, point of sale systems, televisions, smart displays, monitors, entertainment devices, medical devices, virtual reality/augmented reality systems, or so forth. The devices 401 may communicate wirelessly or through any number of fixed/hardwired connections, networks, signals, protocols, formats, or so forth. In one embodiment, the smart phone 402 is a cell phone that communicates with the network 410 through a 5G connection. The laptop 406 may communicate with the network 412 through an Ethernet, Wi-Fi connection, cellular, or other wired or wireless connection.

The data 426 may be collected and sourced from any number of online and real-world sources including, but not limited to the gravitational sensors systems 440, geographic mapping systems, geological databases, websites, seismic databases, historical measurements, and so forth. The data 426 may be captured based on the permissions, authorization, and confirmation of one or more users (e.g., administrators, landowners, surveyors, etc.).

These same data collection sources may be utilized to perform analysis of the data 426. The gravitational sensor systems may utilize any number of mobile, computing, personal assistant (e.g., Siri, Alexa, Cortana, Google, etc.), or other applications. Machine learning and artificial intelligence may be utilized over time to enhance the operation and functionality of the system 400 and other devices within the system 400, such as the gravitational sensor systems 440.

The data 426 may also include location-based information. For example, the location of the gravitational sensor systems 440 and relative locations/proximity may be stored in the data 426. Location information may be determined automatically by global positioning systems, wireless triangulation, user entered data, measurements, or distances. For example, relative distances between different gravitational sensor systems may be determined in order to provide specific location information and generate a grid corresponding to the exploration area.

The data 426 may also include surveys and questionnaires. Responses to surveys and questionnaires may be one of the best ways to gather and inform information regarding the user's property, known natural resource information (e.g., deposits, veins, seems, depth, resource per ton, drill hole or exploration data, etc.), geographic information, interests, and preferences that may not be able to be determined in other ways due to privacy, entity names, applicable laws, and so forth. The ability to gather real-world consumer insights may help complete or round out a user, geographical, property, or measurement profile. The surveys and questionnaires may be performed digitally (e.g., websites, extensions, programs, applications, browsers, texting, or manually (e.g., audibly, on paper, etc.).

The cloud system 414 may aggregate, manage, analyze, and process the data 426 to generate the predictions 427 and communications 428. The data 426 may be received from or across the Internet and any number of networks, sources 431, and third-party resources 430. For example, the networks 410, 412, and cloud system 414 may represent any number of public, private, virtual, specialty (e.g., mining, geographic, seismic, etc.), or other network types or configurations. The different components of the system 400, including the devices 401 may be configured to communicate using wireless communications, such as Bluetooth, Wi-Fi, or so forth. Alternatively, the devices 401 may communicate utilizing satellite connections, Wi-Fi, 4G, 5G, 6G, LTE, personal communications systems, DMA wireless networks, and/or hardwired connections, such as fiber optics, T1, cable, DSL, high speed trunks, powerline communications, and telephone lines. Any number of communications architectures, protocols, standards, or signals including client-server, network rings, peer-to-peer, n-tier, application server, mesh networks, fog networks, or other distributed or network system architectures may be utilized. The networks 410, 412, and cloud system 414 of the system 400 may represent a single mining service provider, communication service provider, or multiple services providers.

The sources 431 may represent any number of clearing houses, web servers, service providers (e.g., mining, mapping systems, communications, etc.), distribution services (e.g., text, email, video, etc.), media servers, platforms, distribution devices, or so forth. In one embodiment, the sources 431 may represent the businesses that purchase, license, or utilize the data 426, predictions 427, and communications 428, such as property owners, mining companies, drillers, exploration groups, and other interested parties. In one embodiment, the cloud system 414 (or alternatively the cloud network) including the data platform 420 is specially configured to perform the illustrative embodiments utilizing information from the gravitational sensor systems 440 and may be referred to as a system or platform.

The cloud system 414 or network represents a cloud computing environment and network utilized to receive, aggregate, process, manage, generate, and distribute the data 426, predictions 427, and communications 428. The cloud system 414 may also implement an encrypted system or blockchain system for managing or monetizing and tokenizing the data 426, predictions 427, and communications 428. The cloud system 414 allows data 426, predictions 427, and communications 428 from multiple landowners, companies, exploration groups, users, managers, or service providers to be centralized. In addition, the cloud system 414 may remotely manage configuration, software, and computation resources for the devices of the system 400, such as devices 401 and the gravitational sensors systems 440. The cloud system 414 may prevent unauthorized access to data 426, predictions 427, communications 428, tools, and resources stored in the servers 416, databases 418, and any number of associated secured connections, virtual resources, modules, applications, components, devices, or so forth. In addition, a user may more quickly upload, aggregate, process, manage, view, and distribute data 426 (e.g., sensor measurements, locations, relative distances, profiles, updates, surveys, content, etc.), predictions 427, and communications 428 where authorized, utilizing the cloud resources of the cloud system 414 and data platform 420.

The cloud system 414 allows the overall system 400 to be scalable for quickly adding and removing gravitational sensor systems 440, users, businesses, properties, logic, algorithms, programs, scripts, or other users, devices, processes, or resources. Communications with the cloud system 414 may utilize encryption, secured tokens, secure tunnels, handshakes, secure identifiers (e.g., passwords, pins, keys, scripts, biometrics, etc.), firewalls, digital ledgers, specialized software modules, or other data security systems and methodologies as are known in the art.

The servers 416 and databases 418 may represent a portion of the data platform 420. In one embodiment, the servers 416 may include a web server 417 utilized to provide a website, mobile applications, and user interface (e.g., user interface 407) for interfacing with numerous users, gravitational sensor systems 440, devices, or so forth. Information received by the server 416 (e.g., web servers, application servers, etc.) may be managed by the data platform 420 managing the servers 416 and associated databases 418. For example, the server 416 may communicate with the database 418 to respond to read and write requests. For example, the servers 416 may include one or more servers dedicated to implementing and recording blockchain transactions and communications involving the data 426, predictions 427, and communications 428. In one example, the databases 418 may store a digital ledger for updating information relating to the user's data 426, predictions 427, and communications 428 as well as utilization of the data 426 (e.g., negotiated agreements and transactions, legal communications, etc.). For example, the predictions 427 or communications 428 may be packaged in digital tokens that may be securely communicated to any number of relevant parties or managed and monetized utilizing blockchain.

The databases 418 may utilize any number of database architectures and database management systems (DBMS) as are known in the art. The databases 418 may store the raw and processed data 426. For example, the databases 418 may store client/property/owner information or profiles, received gravitational wave signals, location, orientation, and position information for the gravitational wave systems, processed data, predictions 427, communications 428, and other applicable data and information. Any number of secure identifiers, such as usernames, passwords, secondary verifications, pins, keys (e.g., hardware, software, etc.), biometrics, codes, may be utilized to ensure that the database 418 and other aspects of the system 400 are not improperly shared or accessed. The databases 418 may include all or portions of a digital ledger applicable to one or more block chain transactions including token generation, management, exchange, transactions, and so forth.

The user interface 405 may be made available through the various devices 401 of the system 400. In one embodiment, the user interface 405 represents a graphical user interface, audio interface, or other interface that may be utilized to manage data, company profiles, predictions 427, communications 428, and other information. For example, the user may enter, or update associated data 426 utilizing the user interface 405 (e.g., browser or application on a mobile device). The user interface 405 may be presented based on execution of one or more applications, browsers, kernels, modules, scripts, operating systems, or specialized software that is executed by one of the respective devices 401.

The user interface 405 may display current and historical data as well as trends. The user interface 405 may be utilized to set the user preferences, parameters, and configurations of the gravitational sensors systems 440 or devices 401 as well as upload and manage the data 426, predictions 427, and communications 428. The user interface 405 may also be utilized to communicate the predictions 427 through the devices 401 (e.g., displays, indicators/LEDs, speakers, vibration/tactile components, etc.) whether visually, audibly, tactilely, or any combination thereof.

In one embodiment, the system 400 or the cloud system 414 may also include the data platform 420 which is one or more devices utilized to enable, initiate, generate, aggregate, analyze, process, and manage gravitational measurements, data 426, predictions 427, communications 428, and so forth with one or more communications or computing devices. The data platform 420 may include one or more devices networked to manage the cloud network and system 414. For example, the data platform 420 may include any number of servers, routers, switches, or advanced intelligent network devices. The data platform 420 may represent one or more web servers that perform the processes and methods herein described. The cloud system 414 may manage block chain management of the data 426 utilizing block chain technologies, such as tokens, digital ledgers, hash keys, instructions, and so forth.

In one embodiment, the logic engine 422 is the logic that controls various algorithms, programs, hardware, and software that interact to receive, aggregate, analyze, process, map, communicate, and distribute data 426, predictions 427, communications 428, graphical and text-based content, transactions, alerts, reports, messages, or so forth. The logic engine 422 may utilize any number of thresholds, parameters, criteria, algorithms, instructions, or feedback to interact with the gravitational sensor systems 440, devices 401, users, and interested parties and to perform other automated processes. In one embodiment, the logic engine 422 may represent a processor. The processor is circuitry or logic enabled to control execution of a program, application, operating system, macro, kernel, or other set of instructions. The processor may be one or more microprocessors, digital signal processors, application-specific integrated circuits (ASIC), central processing units (CPUs), field programmable gate arrays (FPGA), or other devices suitable for controlling an electronic device including one or more hardware and software elements, executing software, instructions, programs, and applications, converting and processing signals and information, and performing other related tasks. The processor may be a single chip or integrated with other computing or communications elements.

The memory 424 is a hardware element, device, or recording media configured to store data for subsequent retrieval or access at a later time. The memory 424 may be static or dynamic memory. The memory 424 may include a hard disk, random access memory, cache, removable media drive, mass storage, or configuration suitable as storage for data 426, predictions 427, communications 428, instructions, and information. In one embodiment, the memory 424 and logic engine 422 may be integrated. The memory 424 may use any type of volatile or non-volatile storage techniques and mediums. In one embodiment, the memory 424 may store a digital ledger and tokens for implementing a blockchain processes.

In one embodiment, the cloud system 414 or the data platform 420 may coordinate the methods and processes described herein as well as software synchronization, communication, and processes. The third-party resources 430 may represent any number of human or electronic resources utilized by the cloud system 414 including, but not limited to, businesses, entities, organizations, individuals, government databases, private databases, web servers, research services, and so forth. For example, the third-party resources 430 may represent mapping companies, satellite systems, seismic resources, advertisement and marketing agencies, verification services, block chain services, payment providers/services, and others that pay for rights to use or receive the data 426, predictions 427, communications number 428, and other information.

The third-party resources 430 may represent any number of electronic or other resources that may be accessed to perform the processes herein described. For example, the third-party resources 430 may represent government websites/servers, private websites/servers, databases, websites, programs, services, and so forth for verifying the data 426, predictions 427, and communications 428.

Various data and property owners that access the data platform 420 may legally extract and tokenize the data 428, predictions 427, and communications 428 for use in an exchange provided by the system 400 for identifying and tracking data 426 utilizing automatic data extraction tools. Any number of privacy and data policies may be implemented to ensure that applicable local, State, Federal, and international laws, standards, and practices are procedures are met, followed, and implemented.

The logic engine 422 may also include hardware and perform location processes and other details as described in U.S. Pat. No. 10,123,397 entitled “System, method, and devices for performing wireless tracking” and filed Aug. 10, 2017.

In one embodiment, the logic engine 422 may utilize artificial intelligence. The artificial intelligence may be utilized to enhance data 426, predictions 427, and communications 428 to increase value, utilization, effectiveness, and profits. For example, artificial intelligence may be utilized to review, authenticate, and validate data 426 and predictions 427 that are received by the system 400. The artificial intelligence of the logic engine 422 may be utilized to ensure that the data 426 and predictions 427 are improved, accurately analyzed, and utilized.

In another embodiment, the devices 401 may include any number of sensors, appliances, and devices that utilize long-term and real time measurements and data collection to update the data 426, predictions 427, and communications 428. For example, a sensor network, (e.g., fixed devices, Internet of things (IOT) devices, etc.) may gather gravitational sensor measurements. The data platform 420 may also work in conjunction with hands-free data mining and measurement tools that tracks location, activity, and sensor data from any number of third-party sources. The data 426 may be tracked through any number of environments, locations, and conditions. The predictions 427 may also be generated based on the activities, actions, and location of the gravitational sensor systems 440.

The following provides a more-in-depth and scientific explanation of the science behind the detected gravitational waves and signals that are utilized by the illustrative embodiments. For example, the following may be implemented by the logic engine 422 as logic or algorithms. In one embodiment, the logic engine 422 may utilize tools, such as automatic scripts or programs implemented by MatLab® or MathCAD® to process data and information based on the sensor measurements. In one embodiment, a method of detecting and processing gravitational waves is proposed using a complex Yukawa potential which is non-singular and predicts a dual-wave structure composed of incoming and outgoing waves. The Yukawa potential is the standard inter-particle potential resulting from the exchange of a single massive bosonic (e.g., scalar, vector, or tensor) particles. Using the Yukawa potential, a fundamental gravitational wave frequency associated with the mass of the Universe is calculated to be the equal to Hubble's Constant. The characteristic out wave frequency of the earth is calculated to be 3.38×10⁻⁵ Hz, which is in good agreement with the range of frequency of gravitation waves as predicted by Hawking and Israel. Measurements with a high-resolution accelerometer sampled at 200 Hz down to 1 Hz over a period of 16, 24 and 32 hours demonstrates the signals with the approximately expected frequencies of the earth mass at 1.1×10⁻⁵ Hz and 2×10⁻⁴ Hz for the moon mass. The method proposed is useful for analyzing the earth's gravitational waves for geological exploration and for detecting the presence of Near-Earth Objects. The illustrative novel measurement methods utilized in conjunction with a slight modification to a triangulation algorithm may be utilized to determine the location in Cartesian coordinates (x, y, and z) of a large object in space and potentially large natural resource, mineral, hydrocarbon, or other deposits within the earth.

The following example provides more detail, background, and description regarding the illustrative embodiments may be implemented. The novel detection and utilization of gravity signals may be utilized in various applications not all of which are described herein. The standard, non-singular Yukawa potential or Coulomb potential of electromagnetism is an example of a Yukawa potential is modeled by the following equation (Equation 1):

$$V ( r ) = ( {A}^{2} ) \frac{{e}^{- k r}}{r} \qquad ( Equation 1 )$$

$$V ( r ) = ( {A}^{2} ) \frac{{e}^{- kr}}{r}$$

Where A is the amplitude of the potential, k is a coupling constant associated with the particular force involved (in this case a gravitational constant that covers both the far field case of the familiar Newtonian constant G and near field case of quantum gravity) and r is the range over which the potential acts, in this case the range is assumed to be from 0 to a limited distance encompassed within the Hubble sphere. In this example, Equation 1 is modified by multiplying by a complex exponential which allows for incoming sinusoids wave functions to become a complex exponential as part of a modified Yukawa potential:

$$V ( r ) = ( {A}^{2} ) \frac{{e}^{- k r} {e}^{i ( ω t + ∅ )}}{r} \qquad ( Equation 2 )$$

$$V ( r ) = ( {A}^{2} ) \frac{{e}^{- kr} {e}^{i ( ω t + ∅ )}}{r}$$

Here ω is the wave frequency and Ø is the corresponding phase shift of the wave. In an environment where several of the waves in Equation 2 travel towards a single point (i.e., gravitational sensor) from all directions, with some asymmetry due to the slight variation of the mass density of local space (i.e., ground propagation). This example proposes a situation where the incoming waves meet at single point but also experience rotational asymmetry at a high-level. This would result in waves coming back in the same direction they originally came from, producing an interference pattern based on the changes in ω and Ø. With two potentials of this type oscillating in free space but moving in opposite directions (e.g., incoming, and outgoing waves with positive and negative signals) with possibly a different frequency and different phase shifts, a final potential is determined:

$$V ( r ) = ( {A}^{2} ) \frac{{e}^{- k r} ( {e}^{i ( {ω}_{1} r + {∅}_{1} )} - {e}^{i ( {ω}_{2} t + {∅}_{2} )} )}{r} \qquad ( Equation 3 )$$

$$V ( r ) = ( {A}^{2} ) \frac{{e}^{- kr} ( {e}^{i ( {ω}_{1} t + {∅}_{1} )} - {e}^{i ( {ω}_{2} t + {∅}_{2} )} )}{r}$$

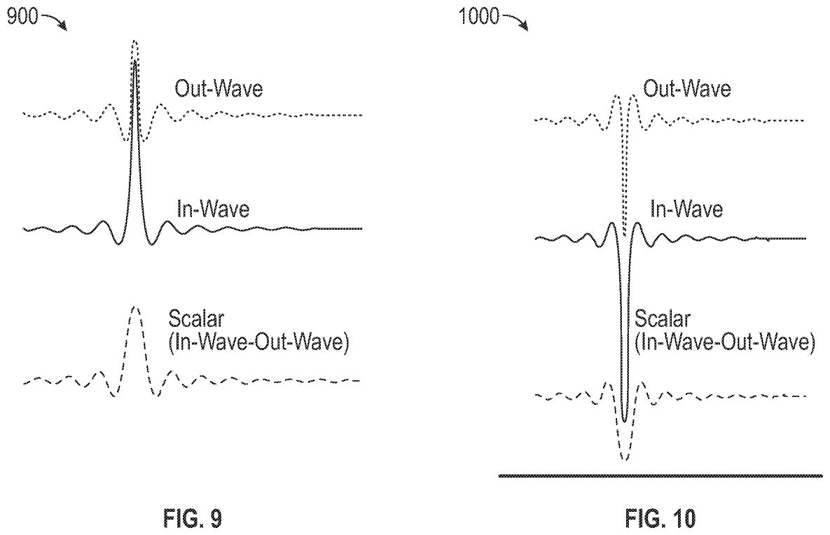

FIG. 9 is a graph 900 illustrating interactions between potentials moving in opposite directions. The graph 900 illustrates some possible interactions of standing wave potentials (i.e., properties of interacting Yukawa potentials) showing that the typical singularity of a particle potential (e.g., an electron) associated with 1/r is replaced with a value of A as r approaches zero in the limit, due to the Yukawa potential.

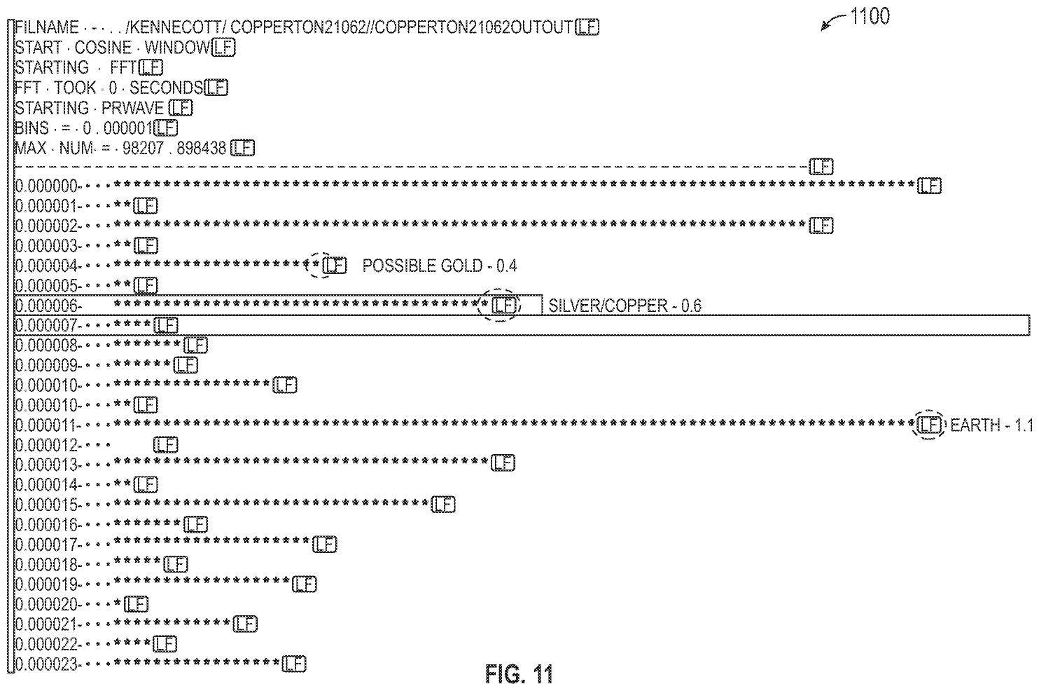

FIG. 10 is a graph 1000 illustrating interactions between potentials moving in opposite directions in accordance with illustrative embodiments. The graph 1000 shows a similar situation where the wave potential has a negative amplitude (relative to the positive amplitude in graph 900 of FIG. 9), resulting in the equivalent of a positron.

As discussed previously, in an environment where several of the waves in graph 1000 travel towards a single point from all directions, there is the possibility of an asymmetry due to the slight variation of the mass density of local space, where the interacting wave center may experience rotational asymmetry (left-handed or right-handed rotation) which may be interpreted as spin of the particle. There is also the possibility of a phase shift between two wave centers which can correlate with the nature of charge (e.g., space tension due to wave centers that are out of phase). In the examples of FIG. 9 and FIG. 10, this would correspond to the wave centers between the electron and positron being out of phase by 180 degrees. Extensive characteristics of the spin and rotation associated with these interacting wave potentials has been evaluated previously by others.

Turning again to FIG. 4, as the spherically symmetric Yukawa potential in Equation 2 has no dependency on the other spherical coordinates of ϕ or φ, the resulting scalar potentials of Equation 2 and Equation 3 may be interpreted as results of a scalar force equation of the form:

F(t)=m\ddot{r}+b\dot{r}+kr

F(t)=m\ddot{r}+b\dot{r}+kr (Equation 4)

Here m is considered a moving and distributed mass density similar to a fluid or elastic medium, b is considered the equivalent of a frictional coefficient, k is an elasticity constant of the corresponding wave medium and r is the range of interaction. By identifying particles of a standing wave nature as being stable (non-transient) wave-centers, this is the equivalent of b=0. For those particles that are transient and decay to lower particles and energy, this occurs when b is a non-zero value, where b is related to the decay constant of b/m. Also, the frequency of the standing wave is controlled by the ratio of elasticity constant to the mass (k/m) with the frequency being determined from:

$$ω = \sqrt{\frac{k}{m}} \qquad ( Equation 5 )$$

$$ω = \sqrt{\frac{k}{m}}$$

The rotational effects of the wave center also result in a change in the speed of the out-going waves based on distance r from the wave center:

v=ωr

v=ωr (Equation 6)

Next, the illustrative embodiments determine gravitational effects of multiple wave centers. To determine k for gravitational effects, we develop an equation for the results of potential energy equivalence of a force acting in a medium with elasticity constant k that is shown to be equivalent to the kinetic energy of a moving mass density in the medium. This is found by substituting ω in equation 5 for ω in equation 6 and squaring both sides, then re-arranging terms and realizing the ½ factor applies for kinetic and potential energy equations:

$$\frac{1}{2} k {r}^{2} = \frac{1}{2} m {v}^{2} \qquad ( Equation 7 )$$

$$\frac{1}{2} k {r}^{2} = \frac{1}{2} m {v}^{2}$$

From a previous determination of the wave velocity v as the speed of light and knowing there are two interacting waves is used to arrive at the equivalent equation 7,

$$\frac{1}{2} k {r}^{2} = m {c}^{2} \qquad ( Equation 8 )$$

$$\frac{1}{2} k {r}^{2} = m {c}^{2}$$

k is determined from Equation 8 for gravitational effects for approximate values of the mass of the universe (m=5.4×10⁵² Kg) and its radius (r=1.9×10²⁶ meters) is estimated,

$$k = \frac{2 m {c}^{2}}{{r}^{2}} = 2.7 x 1 {0}^{17} Newtons / meter \qquad ( Equation 9 )$$

$$k = \frac{2 m {c}^{2}}{{r}^{2}} = 2.7 x 1 {0}^{17} Newtons / meter$$

$$k = \frac{2 m {c}^{2}}{{r}^{2}} = 2.7 x 1 {0}^{17} Newtons / meter$$

Then for waves that are traveling across the Hubble radius of the universe, ω in (Equation 5) for the mass of the Universe is equal to Hubble's constant which closely matches the SI value of 2.27×10¹⁸:

$$ω = \sqrt{\frac{k}{m}} = \sqrt{\frac{2.7 \times {10}^{17}}{5.4 \times {10}^{52}}} = 2.23 \times {10}^{- 18} \frac{radians}{sec} = Hubble ' s Constant \qquad ( Equation 10 )$$

$$ω = \sqrt{\frac{k}{m}} = \sqrt{\frac{2.7 \times {10}^{17}}{5.4 \times {10}^{52}}} = 2.23 \times {10}^{- 18} \frac{radians}{sec} = Hubble ' s Constant$$

$$ω = \sqrt{\frac{k}{m}} = \sqrt{\frac{2.7 \times {10}^{17}}{5.4 \times {10}^{52}}} = 2.23 \times {10}^{- 18} \frac{radians}{sec} = Hubble ' s Constant$$

The results of Equation 10 shows that the fundamental node of standing wave frequencies in this universal model is the Hubble frequency, which is the in-coming wave for all matter in the Universe. Using this model, the cosmological redshift may be explained by understanding the energy transfer through incoming waves and how that energy is perceived as a function of distance, removing the need for a Doppler shift due to universal expansion.

To determine the out-going wave frequency of an object, consider the local mass density around that object. The in-coming waves converge on a local mass density and are rotated and reflected back at a frequency based on local mass density. The results of Equations 7-10 may be applied at an individual wave level but are demonstrated here by aggregating wave affects to a macroscopic level, with many wave centers combining to produce the gravitational effects that are measured.

For the mass of the earth, M_{E}=5.972×10²⁴ Kg the characteristic ω is determined as,

$$ω = \sqrt{\frac{k}{m}} = \sqrt{\frac{2.7 \times {10}^{17}}{5.97 \times {10}^{24}}} = 2.13 \times {10}^{- 4} \frac{radians}{sec} = 3.38 \times {10}^{- 5} Hz \qquad ( Equation 11 )$$

$$ω = \sqrt{\frac{k}{m}} = \sqrt{\frac{2.7 \times {10}^{17}}{5.97 \times {10}^{24}}} = 2.13 \times {10}^{- 4} \frac{radians}{sec} = 3.38 \times {10}^{- 5} Hz$$

For the mass of the Sun, M_{S}=2.0×10³⁰ Kg the characteristic ω is determined as,

$$( Equation 12 )$$

$$ω = \sqrt{\frac{k}{m}} = \sqrt{\frac{2.7 \times {10}^{17}}{2. \times {10}^{30}}} = 3.67 \times {10}^{- 7} \frac{radians}{sec} = 5.85 \times {10}^{- 5} Hz$$

$$ω = \sqrt{\frac{k}{m}} = \sqrt{\frac{2.7 \times {10}^{17}}{2. \times {10}^{24}}} = 3.67 \times {10}^{- 7} \frac{radians}{s e c} = 5.85 \times {10}^{- 5} Hz$$

For the mass of the moon, M_{M}=7.34×10²² Kg the characteristic ω is determined as,

$$( Equation 13 )$$

$$ω = \sqrt{\frac{k}{m}} = \sqrt{\frac{2.7 \times {10}^{17}}{7.34 \times {10}^{30}}} = 1.92 \times {10}^{- 3} \frac{radians}{s e c} = 3.05 \times {10}^{- 4} Hz$$

$$ω = \sqrt{\frac{k}{m}} = \sqrt{\frac{2.7 \times {10}^{17}}{7.34 \times {10}^{22}}} = 1.92 \times {10}^{- 3} \frac{radians}{s e c} = 3.05 \times {10}^{- 4} Hz$$

As the wave energy falls off as 1/r and the amplitude-squared (A²) of the wave is proportional to the rest-energy of the object, similar results of gravitational influence are expected by applying the traditional gravitational potential of GM/r (where A² is proportional to GM/r) to determine the effect from a given distance.

Equation 6 shows the out-wave speed from a mass is proportional to frequency and distance (v=ωr). A given out-wave speed is utilized to determine a time dilation relative to the in-wave speed (which is the speed of light for most cases) through the Lorentz transformation of the out-wave velocities relative to the in-wave velocities, which is the same equation in special relativity:

$$( Equation 14 )$$

$$T = \frac{{T}_{0}}{\sqrt{1 - \frac{{( ω r )}^{2}}{{c}^{2}}}} = \frac{{T}_{0}}{\sqrt{1 - \frac{{v}^{2}}{{c}^{2}}}}$$

Using the earth as an example, ω=2.13×10⁻⁴ and at distance from the center of the earth of r=26,000 km (GPS orbit) it is determined that the time dilation from Equation 14 is:

$$( Equation 15 )$$

$$T = \frac{{T}_{0}}{\sqrt{1 - \frac{{( 2.13 \times {10}^{- 4} \times 26 \times {10}^{6} )}^{2}}{{c}^{2}}}} = 1.0000000001703 = 170.3 psec change$$

$$T = \frac{{T}_{0}}{\sqrt{1 - \frac{{( 2.13 \times {10}^{- 4} \times 26 \times {10}^{6} )}^{2}}{{c}^{2}}}} = 1.0000000001703 = 170.3 psec change$$

Performing the same calculation with General Relativity G44 solution (assuming a non-rotating sphere) gives the same result:

$$( Equation 16 )$$

$$T = \frac{{T}_{0}}{\sqrt{1 - \frac{2 GM}{{rc}^{2}}}} = \frac{{T}_{0}}{\sqrt{1 - \frac{2 * ( 6.67 \times {10}^{- 11} ) ( 5.97 \times {10}^{24} )}{( 26 \times {10}^{6} ) {c}^{2}}}} = 1.000000 \; 0001703 = 170.3 psec change \qquad ( 16 )$$

$$T = \frac{{T}_{0}}{\sqrt{1 - \frac{2 GM}{{rc}^{2}}}} = \frac{{T}_{0}}{\sqrt{1 - \frac{2 * ( 6.67 \times {10}^{- 11} ) ( 5.97 \times {10}^{24} )}{( 26 \times {10}^{6} ) {c}^{2}}}} = 1 \text{.0000000001703} = 170.3 psec change \qquad ( 16 )$$

Various LIGO platforms currently in use or in development have the potential to directly measure static gravitational waves or the result of up-modulation between two static wave sources (such as in binary black-hole mergers). It is speculated that it is most likely going to be the Evolved Laser Interferometer Space Antenna (eLISA) which sees the monthly variation in the static gravitational wave source between the earth and moon (both out wave frequencies fall within the 10⁻⁵ Hz to 10⁻³ Hz range) when fully implemented. The low-frequency static waves from the earth and moon are likely to present as a low-noise background with an orbital variation based on the satellite position with respect to the earth-moon orbit. The static out wave signal of 9.54×10⁻⁸ Hz from the Sun would be measurable with the orbital variation of the European Pulsar Timing Array (EPTA).

In one example, the illustrative embodiments utilize a sensitive accelerometer within the gravitational sensor system 440 that is capable of measuring the earth and moon's gravitational field. The potential of the earth's gravity at a latitude of approximately 40.76 degrees (R_{E} estimated to be 6365 Km):

$$( Equation 17 )$$

$$\frac{{GM}_{E}}{{R}_{E}} = 62,581,681 \frac{J}{Kg}$$

The moon's gravity at surface of the earth (approximate based on latitude and using a mean between apogee and perigee of R_{ME}=380,000 Km) is:

$$( Equation 18 )$$

$$\frac{{GM}_{M}}{{R}_{ME}} = 12,883 \frac{J}{Kg}$$

The ratio of the signal measured from the moon relative to the signal measured from the earth (with the measurement taken on the surface of the earth as in Equation 17) is:

$$( Equation 19 )$$

$$\frac{12,883}{62,581,681} = 2.06 \times {10}^{- 4}$$

This analysis is performed using Newtonian concepts that aggregate over all gravitational wave frequencies and does not take into account the frequency analysis of the moon and earth calculated in Equations 11, 12, and 13, although it is expected the majority of the force components exist at these frequencies. Also, the frequencies calculated in Equations 11, 12, and 13 are what are expected in the far field at multiples radii of these objects however, in the near field of measurement (such as measurements on the earth), it is expected some high-frequency energy to make up the force measured as high-frequency signals have yet to coalesce into the far-field signal. Therefore, it is expected the signal measured from the moon relative to the signal measured from the earth (with the measurement taken on the surface of the earth) as shown in Equation 19 is much closer to unity as the signal of the earth measured on the surface of the earth will be near-field and have a wider distribution of energy across the frequency band, with less energy at the earth's characteristic frequency. The signal of the moon as measured on the surface of the earth is easily considered far field as its radius is 1.73 million meters and the moon's mean distance from the earth is 380 million meters (Distance_{Moon-Earth}/Radius_{Moon}=219). Therefore, a normalized, far-field gravitational measurement of the moon at its characteristic frequency is expected when measured from the surface of the earth, but a weaker than expected signal at the characteristic frequency from the earth due to the near-field frequency spread.

Initially, during the development of the illustrative embodiments, to measure the moon and earth signals at the frequencies calculated in Equation 11 and Equation 13, a fixture or gravitational sensor system was developed that is vibrationally damped across low-frequencies and a high-resolution MEMs accelerometer board was mounted to the fixture. The MEMS accelerometer used may represent any number of accelerometers, such as an accelerometer with a 1.5 g range, 5V DC supply and a sensitivity of 1.33V/g or a range of 2 g and a sensitivity of 2 V/g. The accelerometer is connected as per data sheet recommendations. The accelerometer sensor is mounted to a printed circuit board (PCB) and a mounting structure that reduces vibrational impact on the measurement as shown in FIG. 4. The Sun's characteristic frequency is excluded from the current measurements as the time resolution required to see the Sun's characteristic signal would require a continuous measurement time of approximately 3 years, but it is not believed that a wider-band signal from the Sun influences the measurements regarding the earth and moon.

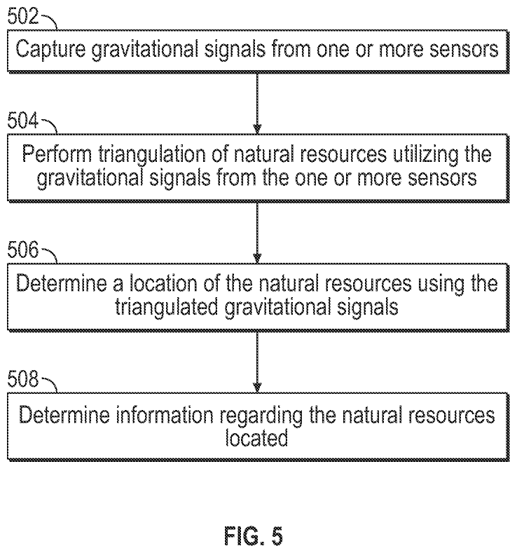

FIG. 5 is a flowchart of a process for using gravitational waves to detect natural resources in accordance with an illustrative embodiment. The process of FIGS. 5-7 may be performed by a system, such as the system 400 of FIG. 4 utilizing the gravitational sensor system 300 of FIG. 3. The process may begin by capturing gravitational signals from one or more sensors (step 502). The gravitational signals may represent gravitational signals associated with the earth, moon, and other planetary bodies or other natural signals inherent within or detectable on the surface of the earth. The sensors may be strategically positioned within or around an exploration area. For example, the sensors may be buried, mounted, or otherwise positioned. In one embodiment, multiple sensors (i.e., four or more gravitational sensors) may be utilized to perform the measurements concurrently or simultaneously. For example, four sensors may be utilized to determine X, Y, and Z coordinates for natural resources (e.g., metals, ores, deposits. oil, gas, water, etc.) or deposits in the exploration area. In another embodiment, one sensor may be moved between different positions to conserve resources. The sensors may operate as stand-alone devices or may communicate with other sensors or systems utilizing a wireless connection or signal. The sensors may capture the gravitational signals for hours, days, weeks, or even months. In one example, the sensors may be positioned for 2 to 4 weeks to get accurate frequency values.

Next, the system performs triangulation of natural resources utilizing the gravitational signals from the one or more sensors (step 504). The triangulation process may be performed by the sensors or by one or more computing devices that receive the captured gravitational signals. As previously described, four or more sensor instruments or boxes may be utilized to perform measurements.

Next, the system determines a location of the natural resources using the triangulated gravitational signals (step 506). The system may determine the location, size, and depth of the natural resources. Location and size information, such as GPS coordinates, latitude and longitude, depth, and other applicable information may be determined. In one embodiment, the system may be integrated with mapping software to provide a detailed three-dimensional map of the natural resources within the exploration area.

Next, the system determines information regarding the natural resources located (step 508). The information may specify the category, type, density, layout, configuration, or other information relating to the natural resources. The determinations may be made utilizing changes for differentials and the phase, frequency, amplitude, or other characteristics or parameters of the gravitational signals. For example, the system may identify metals, such as copper, gold, iron, or silver within the exploration area as well as deposits of oil, natural gas, and/or water. In one embodiment, the measurements may be associated with known assay data or drill data for the soil/ground materials. For example, predictions regarding gold and silver per ounce may be provided by associating the measurements from the sensors with known physical data measured utilizing excavation, drill holes, core measurements, or other verifiable scientific evaluation processes.

In one embodiment, drill data, assay data, or excavation data (altogether “physical data”) may be utilized to ensure that triangulation depths and locations and ore-grade, mineral composition, and material type predictions are accurate. For example, the predictions may be correlated to the physical data to tune prediction results, calculations, FFTs, and other data and information analyzed utilizing the systems, devices, and methods herein described. The physical data may provide soil density data, mineral grade data (e.g., gold grade, silver grade, platinum grade, etc.) to provide information regarding natural resource weight or volume per ground weight or volume within the exploration area.

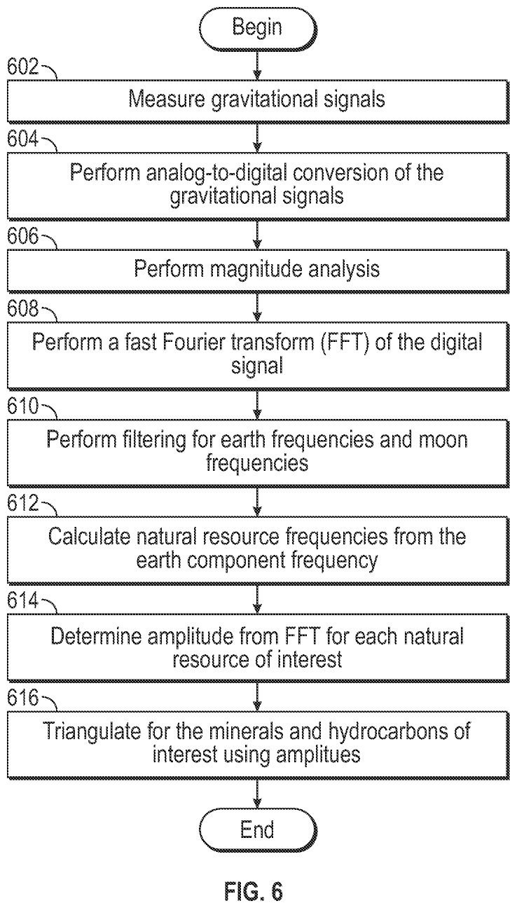

FIG. 6 is a flowchart of a process for processing gravitational signals in accordance with an illustrative embodiment. The process may begin by measuring gravitational signals (step 602). The gravitational signals may represent one or more signals, frequencies, or waveforms detected by the sensors of the sense system. In one embodiment, the gravitational signals are sensed, detected, and measured utilizing a sensor system. A vibrationally dampened highly sensitive accelerometer may be utilized as a portion of the sensor system to measure the gravitational signals. The sensor system may measure the gravitational signals in three axes (e.g., x, y, z). In one embodiment, the sensor system may capture measurements at one sample per second. Other faster or slower sample rates may also be utilized. Sensor measurements may be performed for 1,048,576 seconds (approximately 12.14 days), three weeks, four weeks, or other applicable time periods.

Next, the system performs analog-to-digital conversion of the gravitational signals (step 604). Analog-to-digital conversion may be utilized to convert the analog gravitational signals into quantifiable data that may be more easily processed, analyzed, and stored. As a result, the gravitational signals may be more accurately and reliably processed while minimizing errors. The digital data may be more accurately processed by a single or multiple computing devices (e.g., servers, personal computers, cloud computing systems, supercomputers, mainframes, etc.).

Next, the system performs a fast Fourier transform of the digital signal (step 608). The digitized signal is processed into individual components and thereby provides frequency information about the signal measured during step 602.

Next, the system performs filtering for earth frequencies and moon frequencies (step 610). The system may also perform filtering for any number of other planetary bodies, events, or effects that may be influencing the gravitational signals (e.g., sun activity, near Earth objects, etc.). In one embodiment, the system may separate the signals into distinct data that may be separately utilized as needed. In one embodiment, the system may truncate the FFT spectrum above 0.01 Hz to cut-off earth and moon frequencies as part of step 610. The filtering of step 610 may also be performed for any irrelevant data.

Next, the system calculates natural resource frequencies from the earth component frequency (step 612). In one example, the earth frequency (1.1×10⁻⁵ Hz) is multiplied by the square root of the ratio of the rock density of the target material density. The system may also determine the surrounding hard-rock density through measurement or calibration. Most hard-rock densities fall in the range of 2-4 g/cm³ (grams per cubic centimeter). The frequency of 1.1×10⁻⁵ Hz is found to be consistent with the density of most hard rock types or approximately 2.6 grams/cm³.

As the gravitational wave velocity and refraction angle changes as it goes through materials of different density (similar to sound waves) to a first order this follows the formula:

$$( Equation 21 )$$

$$v = \sqrt{\frac{Shear Force}{density}}$$

Taking a ratio of two different densities in (Equation 21) assuming the same shear force (which is over an area larger than any mine shaft) gives the ratio of velocities to densities (using copper as an example):

$$( Equation 22 )$$

$$\begin{matrix} \text{} Vcopper / Vbedrock = \sqrt{\frac{Density\_bedrock}{density\_copper}} \\ = \sqrt{\frac{2.6}{8.96}} = 0.54\end{matrix}$$

Based on the ratio in (Equation 22) for hard rock and copper, we can write similar equations for the wave velocity that refracts differently while going through silver and gold as follows:

$$( Equation 23 )$$

$$\begin{matrix}Vsilver / Vbedrock = \sqrt{\frac{Density\_bedrock}{density\_silver}} \\ = \sqrt{\frac{2.6}{10.49}} = 0.2\end{matrix}$$

$$( Equation 24 )$$

$$\begin{matrix}Vgold / Vbedrock = \sqrt{\frac{Density\_bedrock}{density\_gold}} \\ = \sqrt{\frac{2.6}{19.32}} = 0.36\end{matrix}$$

$$( Equation 25 )$$

$$Frequency = \frac{velocity}{wavelength}$$

$$( Equation 26 )$$

$${Mineral}_{Frequency} = 1.1 \times {10}^{- 5} Hz * \sqrt{\frac{Density\_bedrock}{density\_mineral}}$$

### Also,

As the wavelength is considered fixed based on the fixed mass of the Earth (from Wave Structure of Matter concepts) in this example, the increase in local density going from bedrock to copper (Equation 22) results in a decrease of wave velocity (Equation 22) and therefore a decrease in wave frequency by a factor of 0.54. These formulas are verified by measurements near the Bingham copper mine in Utah as compared to the bedrock background in Lehi and Saratoga Springs, Utah. The measurement of gold in (Equation 24) requires a higher frequency resolution than copper or silver, from the calculated frequency of 0.36×10⁻⁵ Hz in (Equation 24) which is still 5× oversampled from the fundamental frequency of two weeks. In order to see the difference between gold and tungsten or silver and palladium, it is estimated that a four-week run is required to meet this time resolution as these signals are less than the fundament sampling frequency at two weeks resolution. Also, Equation 26 can be used to determine the density of bedrock if a significant amount of the density of the mineral is already known. In some cases, it is easier to calibrate the density of the bedrock in an area that has water, because this higher-frequency signal for water is greatly oversampled compared to a higher-density mineral and the known frequency of water as measured at many locations can be applied to determine the bedrock density from Equation 26. In one embodiment, known features, such as water, may be utilized to determine the density of the bedrock for calibration and more accurate analysis of the measurements.

The location of bedrock and other natural barriers may also be determined. The location of bedrock or other layers may be extremely important for mining, construction, archeological efforts, scientific analysis, and other determinations that may be performed. For example, the water frequency may be utilized to reverse solve for density knowing the exact density of water is 1 g/cc. As a result, the bedrock density may be determined. The bedrock density may be determined before the other natural resource (e.g., gold, silver, etc.) frequencies are determined. The calibrated bedrock density often has a lower density than metals and may be utilized with the known frequency for water to determine the presence of natural resources. The various frequencies of natural resources may also be utilized over time to solve or reverse solve for all of the applicable variables associated with the analyzed results and predictions.

Several drill samples were taken from measurements of silver at the Escalante mine in Beryl, Utah. These drill samples showed ounces per ton of silver at various depths and was calibrated using the 500-foot depth as a baseline. From these results a formula was extracted for ounce per ton of silver as follows:

$$( Equation 27 )$$

$${Mineral\_Silver}_{ounce - per - ton} = \frac{( Distance ( feet ) / 500 ) {( Measured\_value )}^{2}}{16}$$

Similar to the silver calibration in Equation 27, a few flow rates were measured from measurements at the Escalante mine in Beryl, Utah. These measurements were also at a 500-foot depth as a baseline. Also, measurements from a mine in Goshen Canyon, Utah had boxes positioned at the same altitude on the side of the hill across from the Currant Creek, which runs through the canyon. There were two boxes at a 45-degree angle and a radial distance of 424 meters from Currant Creek and two boxes at a 37-degree angle vector to the creek. From these results and obtaining the flow rate of Currant Creek from Utah county records as 9782 gallons per minute, a formula (equation 28) was extracted for the flow rate (in gallons per minute) of water based on measurements from our accelerometer device and was correlated with the flow-rate measurements in Escalante to produce the following formula:

$$( Equation 28 )$$

$${Water}_{gallon\_per \_minute} = \frac{9782 * ( Distance ( feet ) / 424 ) {( Measured\_value )}^{2}}{1089}$$

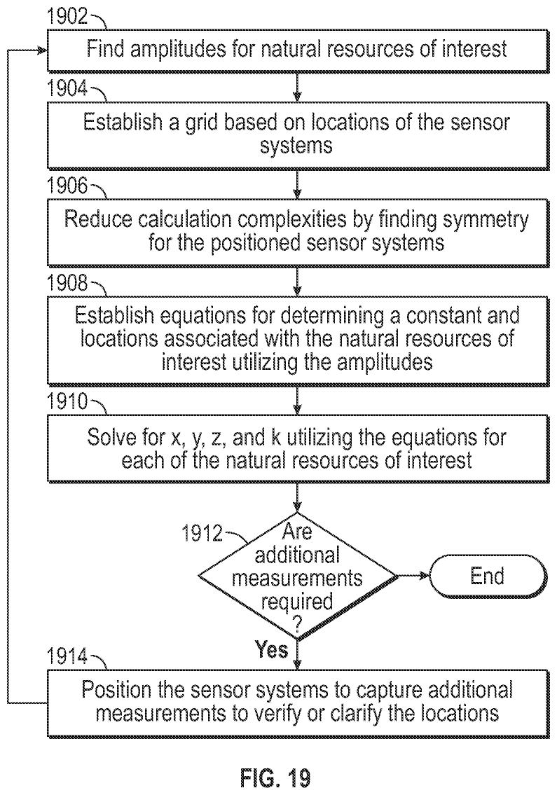

Next, the system determines amplitude for each natural resource of interest (step 614). Step 614 may also be referred to as performing magnitude analysis. The system may determine the amplitude of the various portions of the gravitational signals for analysis. For example, the measured x, y, and z values to determine a magnitude of the vectors: Magnitude=sqrt(x\hat{ }2+y\hat{ }2+z\hat{ }2). The system may perform a radix-2 or radix-4 FFT on the time series data to determine a magnitude value. The amplitude is determined (from the vertical axis) of the FFT corresponding to the frequency (horizontal axis) for the various natural resources (e.g., minerals, hydrocarbons, water/water composition, etc.). As an example, three measurements over two weeks each were taken around the Bingham Copper mine anywhere from 1-2 miles from the center of the pit, reveal a frequency shift from 1.1×10⁻⁵ Hz to 0.59×10⁻⁵ Hz, (which is a decrease of a factor of 0.54 as predicted by (Equation 22)) as shown in FIG. 19. The measurements described herein were all taken on public land or private land surrounding the areas in question to comply with applicable laws and regulations. The frequency of the signal passing through silver will only change by a small amount when compared to copper, in fact it will be 0.55×10⁻⁵ Hz for silver compared to 0.59×10⁻⁵ Hz for copper, requiring a much longer measurement time to resolve this difference.

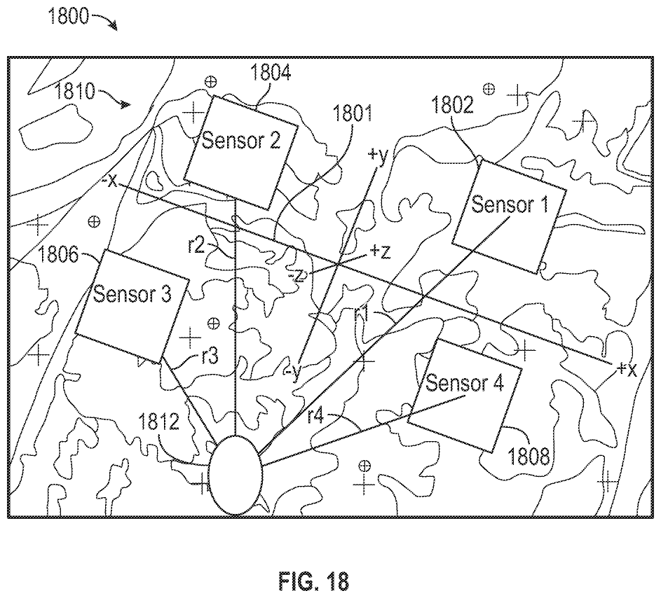

Next, the system triangulates the minerals and hydrocarbons of interest using amplitudes (step 616). As previously noted, the applicable process may be performed for any number of natural resources from gold and natural gas to copper and water. FIG. 18 shows the example of a grid in Eureka, UT established between the measurement boxes 1 and 2 which determine the x-axis with the box 1 at +37.5 meters and box 2 at −37.5 meters. Boxes 3 and 4 are not shown in the picture but are also used with box 1 and 2 to determine x, y, z, and k (the calibration and material constant). The line perpendicular to the x-axis is the y axis. This grid is used to calculate the location of the source of the copper/silver deposit.

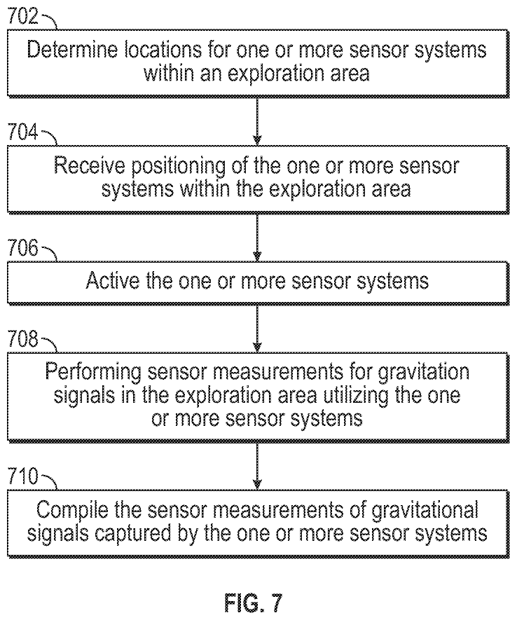

FIG. 7 is a flowchart of a process for utilizing sensor systems in accordance with an illustrative embodiment. The process may begin by determining locations for one or more sensor systems within an exploration area (step 702). These sensor systems may include GPS components for determining a location. In other embodiments, wireless triangulation, radiofrequency communications, geographic marketing, or other processes may be utilized to determine the location of the one or more sensor systems as well as their location, position, and orientation relative to other sensor systems.

Next, the method receives positioning of the one or more sensor systems within the exploration area (step 704). The one or more sensor systems may be positioned by one or more users, exploration professionals, property owners, or others. For example, the one or more sensor systems may be positioned around the periphery/perimeter of the exploration area to achieve the desired measurements. In another embodiment, the one or more sensor systems may be integrated with one or more drones. As a result, the drones may be flown or driven into position. For example, the drones may be driven to an exact position and location determined for the exploration area. The positioning of the one or more systems may be performed automatically based on predetermined locations for the one or more sensor systems integrated with drones. The positioning may include the location, position, and orientation of each of the sensor systems. In one example, the one or more sensor systems may be positioned level to generate optimal readings. In other examples, the one or more sensor systems may not be required to be level or positioned in a particular position or orientation. In one embodiment, the one or more sensor systems may be completely or partially buried to provide a better interface to the ground and/or protect the one or more sensor systems from the elements/weather, animals, humans, or others. The goal is for the one or more sensor systems to be fixedly positioned and left alone for the duration of the measurement time period (e.g., 12 days, 14 days, four weeks, six weeks, etc.). Passive or active markers may be utilized to mark the location of the one or more sensor systems.

Next, the method activates the one or more sensor systems (step 706). The one or more sensor systems may be activated in person or remotely. In one embodiment, a power switch, button, or other interface component may be utilized to turn on or otherwise activate each of the one or more systems. Similarly, the one or more sensor systems may also be utilized to turn off or deactivate the one or more systems when measurements are complete. In another embodiment, a wireless signal or command may be utilized to activate the one or more sensor systems. As a result, the one or more sensor systems may be activated or deactivated as required or necessary.

Next, the method performs sensor measurements for gravitational signals in the exploration area utilizing the one or more sensor systems (step 708). The sensor measurements are performed utilizing various sensors, such as accelerometers, strain gauges, or so forth. These sensor measurements may be captured for a predetermined time period based on the target natural resources (e.g., silver, gold, palladium, tungsten, platinum, water, oil, cave systems, etc.).

Next, the method compiles the sensor measurements of gravitational signals captured by the one or more sensor systems (step 710). The sensor measurements may be saved in one or more memory systems of the one or more sensor systems. These sensor measurements may also be streamed as received, periodically (e.g., once every six hours, daily, weekly, etc.), or once the sensor measurements are completed for the designated time period. The raw sensor measurements may be processed in a larger process or as part of a multi-stage process, such as data transfer to a secure storage location, data review and analysis, FFT analysis for minerals, location analysis, and result compilation (e.g., 3D models, Keyhole Markup Language (KML) files, mapping documents, etc.). In one embodiment, results may be expressed in KML files that may be securely shared in either two-dimensional or three-dimensional maps. Any number of other mapping, modeling, or results based files, programs, or specifications may also be utilized. In one embodiment, points may be created on the model for each measurement associated with a particular type of natural resource. For example, any number of applications (e.g., point cloud viewer, etc.) may display the vertex and face associated with an x, y, and z coordinates for a detected element, mineral, or natural resource.

These sensor measurements captured, saved, and otherwise compiled by the one or more sensor systems may be analyzed or processed by a user or system that downloads the sensor measurements (physically or wirelessly). In another embodiment, the one or more sensor systems may perform “on box” analysis and processing or analysis and processing by a master sensor system. In another embodiment, the one or more sensor systems may communicate the sensor misstatements in real time, periodically, or once completed through one or more wireless or satellite networks for processing by a centralized system, cloud system, or other remote processing system or devices. As previously noted, the one or more sensor systems may be retrieved by a user or automatically based on the movement of the applicable drones.

These sensor measurements of the gravitational signals may be processed to generate the predictions regarding the natural resources within the exploration area. The predictions may indicate the location, depth, shape, orientation, and configuration of the natural resources to facilitate drilling, extraction, or other testing and/or removal processes. In one embodiment, the predictions include an underground geographic mapping of the applicable natural resources within the exploration area. The geographic mapping may also show the surface topography, structure, terrain, and features as well as the subterranean structure and features as measured by the one or more sensor systems and other available images, data, mapping information, and so forth. As a result, the property owner, mining company, drilling company, or other interested party may have better information regarding the potential ease or difficulty of testing for or extracting the natural resources.

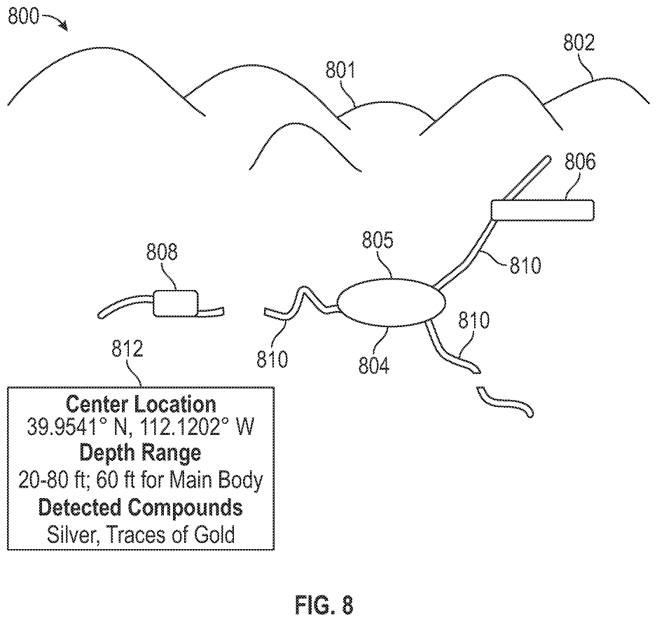

FIG. 8 is a pictorial representation of a prediction 800 in accordance with an illustrative embodiment. The prediction 800 is a visual, audio, and/or text-based prediction for geography 801 associated with an exploration area 802. The prediction 800 may be shown utilizing a graphical user interface, program, mobile application, secured website/browser, augmented reality, virtual reality, mapping system, geographic mapping system, or so forth. The prediction 800 may represent the actual results of the geological exploration processed utilizing gravity waves and mapped to show natural resources 805. The exploration area 802 may represent a greenfield area, claim, or project where minimal to no previous natural resource exploration has been performed. The exploration area 802 may alternatively represent a brownfield area, claim, or project may range from advanced natural resource development stage to a proven producer of natural resources (e.g., silver mine).

In one embodiment, the prediction 800 includes a main deposit 804, deposits 806, 808, and veins 810. The prediction 800 may also include text 812 including a location or multiple locations/coordinates, a depth, types of natural resources (e.g., silver, gold, uranium, palladium, etc.), and other applicable information.

As shown, the prediction 800 may show the approximate size, shape, and location of the main deposit 804, deposits 806, 808, and veins 810. The prediction 800 may be converted to any format, display system, software, or geographic mapping system utilized by a mining company, property owner, driller, or other applicable party. The location of the main deposit 804 and deposits 806, 808 provide the applicable party knowledge and information that may be utilized to develop any number of efficient, environmental, safe, effective, and/or lucrative strategies for extracting the natural resources 805.

For example, the property owner may determine that deposit 808 is not worth pursuing in the near future, but instead may start by extracting the deposit 806 that is not so deep within the exploration area 802 before moving to the main deposit 804. The prediction 800 allows the property owner to maximize testing, extraction, protection, or other goals for the natural resources 805.

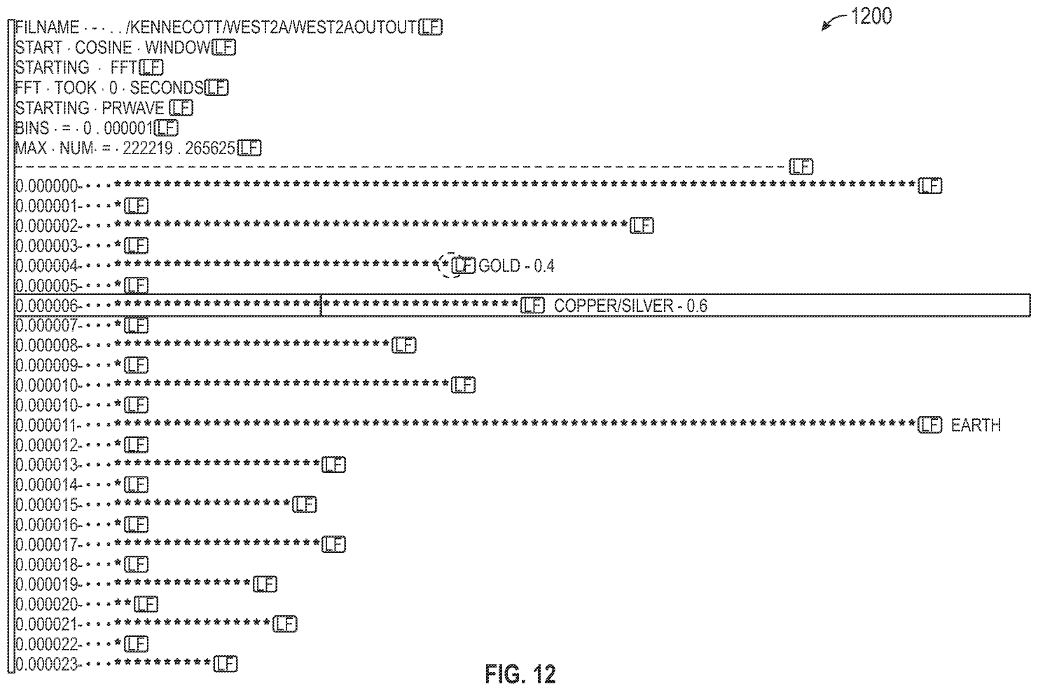

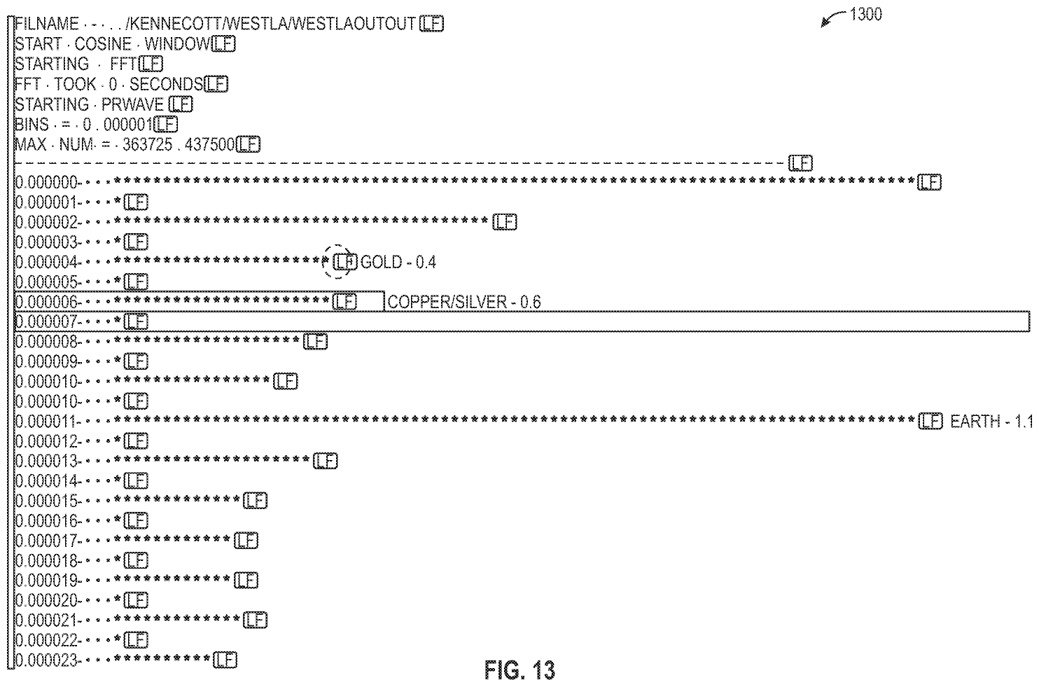

FIGS. 11-13 are captured data in accordance with illustrative embodiments. The measurements around the Bingham mine over a two-week period are shown in FIG. 11. Data 1100 of FIG. 11 shows the potential presence of gold, silver, and copper. In this example, the data 1100 is from a single sensor measurement system. FIGS. 12 and 13 each respectively, show data 1200 and data 1300 that are each captured by a sensor measurement system. As previously disclosed, multiple sensor measurement systems are utilized as part of a sensor network or overall system. The data 1100, 1200, and 1300 of FIGS. 11-13 are taken from two-week measurements around the Bingham Mine. FIGS. 11-13 show data 1100, 1200 and 1300 including Fast Fourier Transforms which detail the amplitude of frequency components, where the frequency components correspond to the density of minerals as shown in Equation 26 and, the Figures show the measurement of the Copper and Gold frequencies as compute by Equation 26. The amplitudes that correspond to these frequency components are the measured value of the gravitational wave at the point of the sensor. The amplitudes indicate a presence of stronger minerals related to the corresponding mineral or water frequency. The amplitude of the Earth frequency at 11 μHz as shown in Equation 26 has consistently been measured at a value of 81 for environments that consist mostly of the same material. The introduction of materials of different densities near the surface of the measurement produces lower values of the Earth signal at 11 μHz due to the refraction of the signal through the material of different density. The closer the material of different density is to the surface where the measurement is made, the more of a change occurs by diffracting the measured Earth signal to a sharper angle, which also changes the signal's speed and frequency from the equation speed=frequency*wavelength (where the wavelength is constant). This is similar to how the Fresnel effect works with light at the aperture of a lens (the ore body of different density being similar to the lens). At further depths below the surface of the Earth where materials of different density exist, the diffraction angle is resolved over distance in the far field in the same way that light coalesces in the far field from a lens. In the far field of the Earth signal, many parts of the Earth signal coalesce that are off axis of the measurement, causing it to converge on a single, composite frequency of 11 μHz.

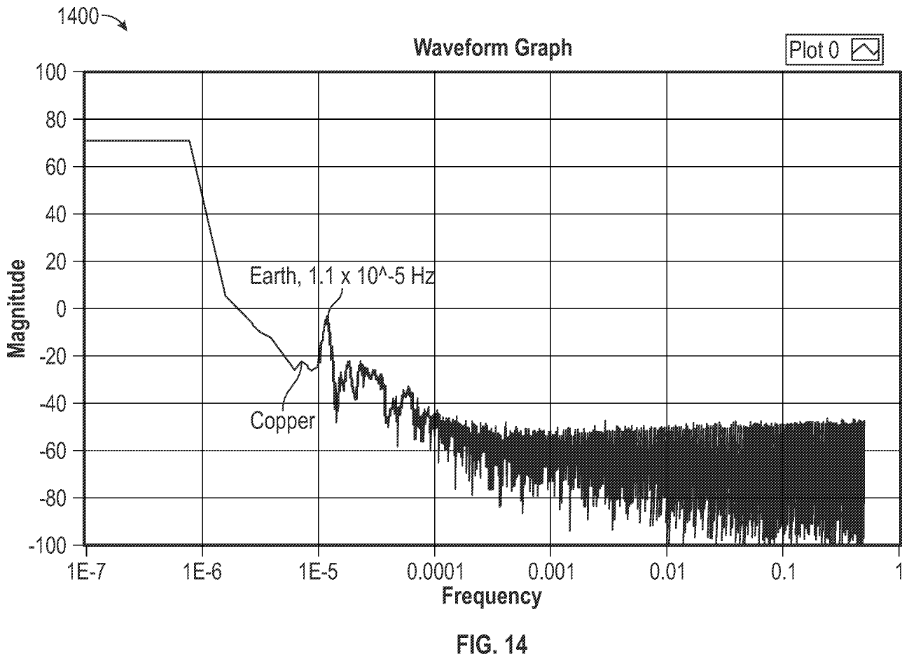

FIG. 14 is a continuous graphical version of the Fast Fourier Transform (FFT) of the captured data as a continuous wave form in accordance with an illustrative embodiment. The data was collected over a period of one week with a sample rate of 1 sample/sec. Based on these parameters, the frequency resolution is 1.65 μHz A graph 1400 of FIG. 14. shows the frequency on the x-axis and the magnitude of the capture signal on the y-axis. FIG. 14 was taken near the Bingham mine and shows the Earth signal at 11 μHz and a significant amplitude at a slightly lower frequency due to a large amount of copper in the bottom of the Bingham mine. This early experiment demonstrates the necessity of higher frequency resolution to measure the frequency shift of copper, which is resolved at approximately 6 μHz, more than 3× the sampling frequency (1.65 μHz) in this measurement. The various calculations and analytics may be performed as an algorithm, script, hardware logic, software, or other form of processing.

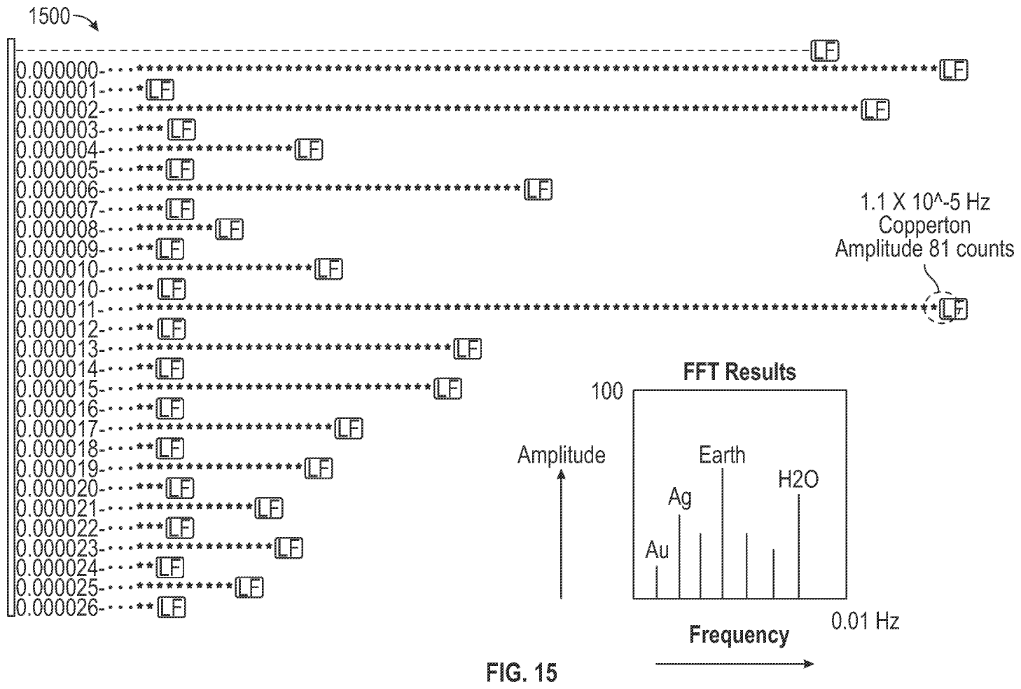

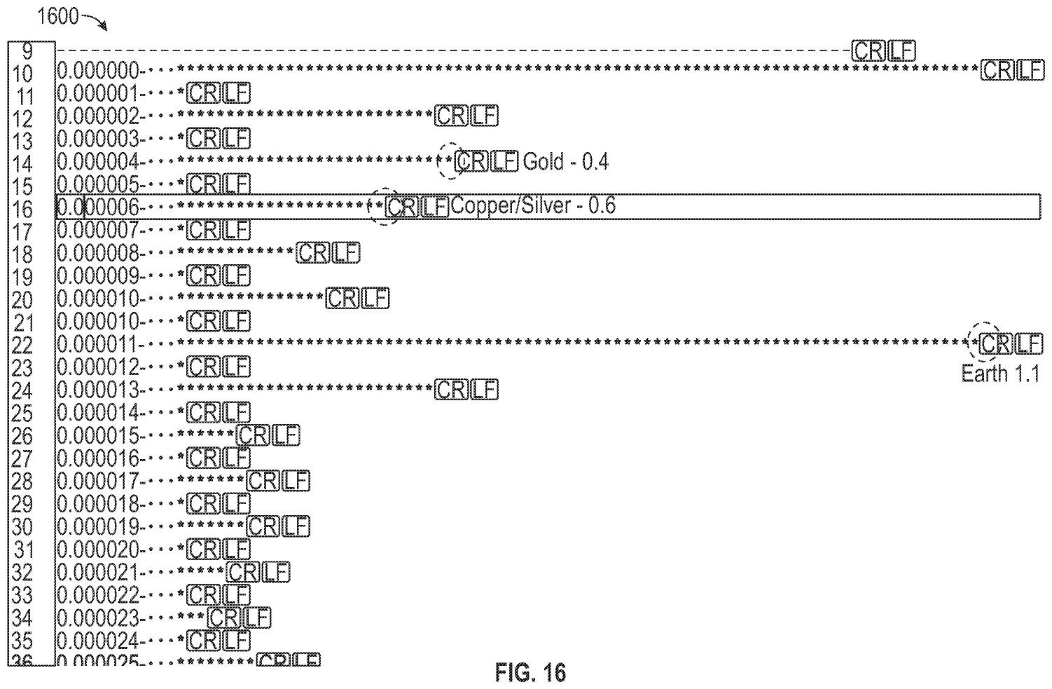

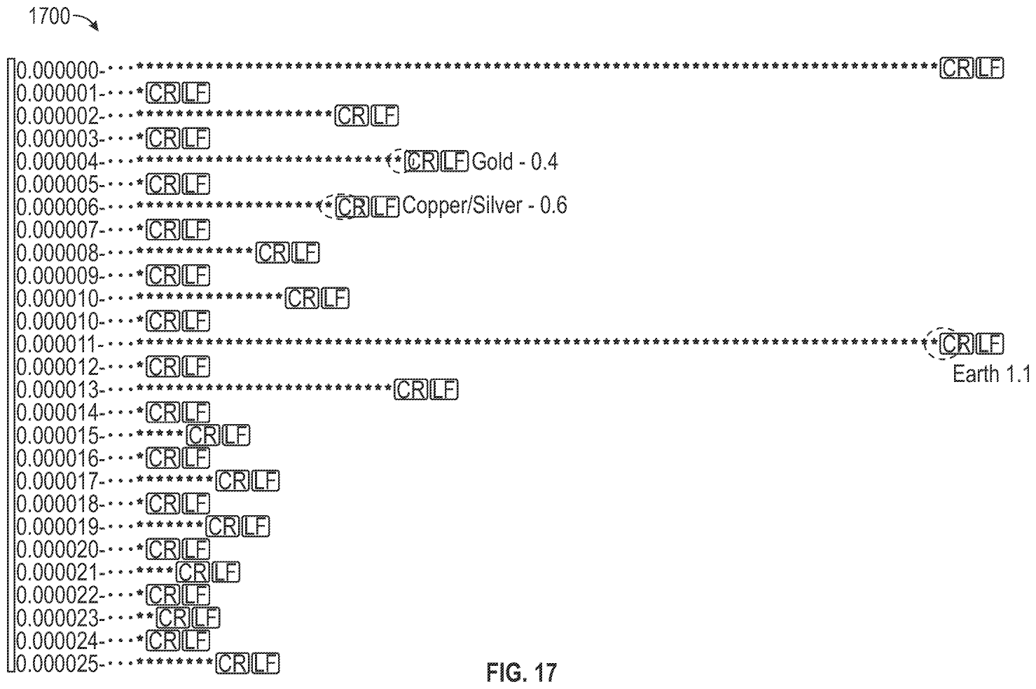

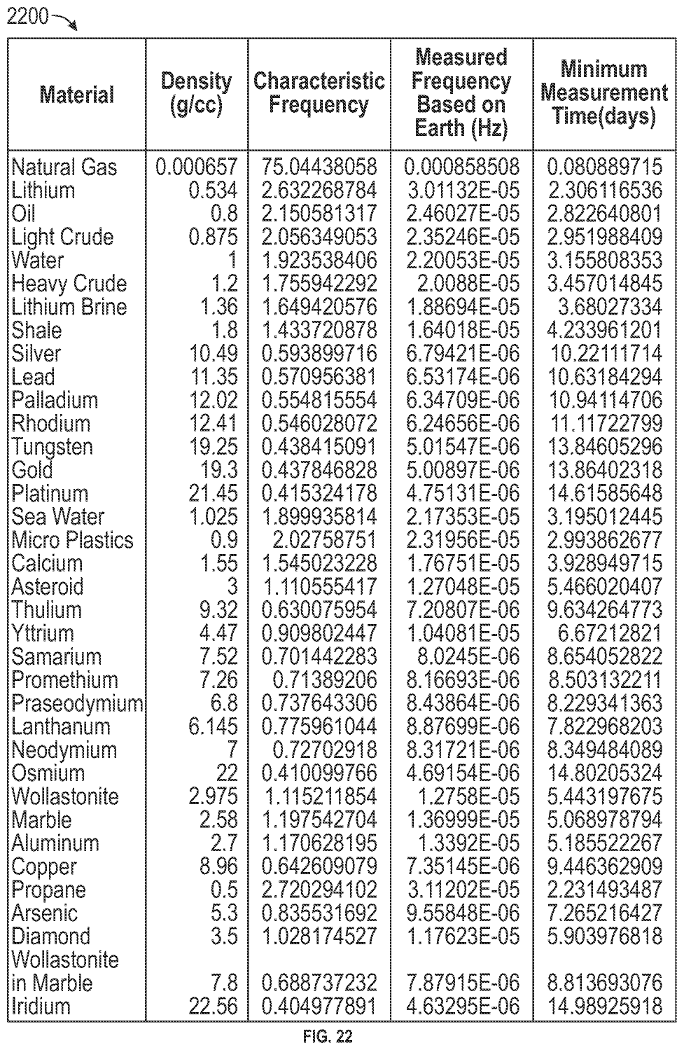

FIGS. 15-17 are captured data in accordance with illustrative embodiments. FIG. 15 shows data 1500 from two weeks of measurements from a sensor system (sensor system 1) near the Bingham copper mine. FIG. 15 illustrates how the frequencies for each of the various natural resources, such as gold, silver, and water each have a corresponding amplitude. The various element or material information (see FIG. 22) may then translate into grams/ton, ounces/ton, gallons/minute, or so forth. The translation of data is performed after the triangulate to find the depth and then apply the formula as in Equation 26. FIG. 16 shows data 1600 for two weeks of measurements from near a sensor system (sensor system 2) near Copperton, Utah which separated from the Bingham copper mine (see FIG. 15). FIG. 17 shows data 1700 for two weeks of measurements from a sensor system (sensor system 3) near Herriman Utah. The amplitude of the measurement over this two-week period was measured to be 81 counts as shown in FIG. 21. The 81 count is consistent in other measurements across the state, this amplitude changes when large amounts of minerals are nearby as the gravitational wave energy is split across the frequencies based on the density of the minerals, leaving less energy in the 1.1 band (lowering it below 81 counts).

The ratio of the amplitude measurements between data 1600 of FIG. 16 measured by sensor system 2 and data 1700 of FIG. 17 measured by sensor system 3 is 81/61=1.32, a 30% increase in amplitude for a 30% decrease in distance. This verifies the decrease in radiative energy as 1/r, predicted based on the illustrative embodiments. Knowing the radiative decrease as a function of distance allows for the triangulation of four vectors (i.e., three vectors for unknown coordinates, and one vector for an unknown material constant) to the source of maximum amplitude, which corresponds to the center of mass of the ore body (or ore bodies).

FIG. 18 is a map 1800 of measured data in accordance with illustrative embodiments. A system or device may implement the map 1800 as a user interface, mapping application, processing scenario, or so forth. The map 1800 shows a grid 1801 including an x, y, and z axis as shown. The grid 1801 is created between a first sensor system 1802 (x1, y1), a second sensor system 1804 (−x2, y2), a third sensor system 1806 (−x3, −y3), and a fourth sensor system 1808 (x4, −y4) (altogether sensor systems 1810). Various real-world measurements were performed to survey a location as embodied by the map 1800 of FIG. 18. Various triangulation systems and methods may be utilized as described in U.S. Pat. No. 10,123,297 entitled “System, method and devices for performing wireless tracking” which is incorporated by reference herein.

As shown, each sensor has a radial vector magnitude from the sensor to a location 1812 of natural resources. Each of the sensor system 1810 have a radial vector magnitude (i.e., r1, r2, r3, r4) from each of the sensor systems 1810 to the triangulated point of the location 1812. k/rₙ=k/\sqrt{(xₙ)²+(yₙ)²+(zₙ)²} where n=1, 2, 3, 4 for each of the sensor systems 1810. Four sets of equations with four unknowns (equal to the four known values from each sensor gives the x, y, z, and k results.

Four equations for measured value 1-4 (for the FFT amplitudes), solves for four unknowns (x, y, z, and k) with offsets xₙ, yₙ, zₙ from the x and y axis are as follows:

$$\frac{k}{\sqrt{{( x - {x}_{1} )}^{2} + {( y - {y}_{1} )}^{2} + {( x - {z}_{1} )}^{2}}} = \frac{k}{{r}_{1}} = measured value 1$$

$$\frac{k}{\sqrt{{( x - {x}_{2} )}^{2} + {( y - {y}_{2} )}^{2} + {( x - {z}_{2} )}^{2}}} = \frac{k}{{r}_{2}} = measured value 2$$

$$\frac{k}{\sqrt{{( x - {x}_{3} )}^{2} + {( y - {y}_{3} )}^{2} + {( x - {z}_{3} )}^{2}}} = \frac{k}{{r}_{3}} = measured value 3$$

$$\frac{k}{\sqrt{{( x - {x}_{4} )}^{2} + {( y - {y}_{4} )}^{2} + {( x - {z}_{4} )}^{2}}} = \frac{k}{{r}_{4}} = measured value 4$$

FIG. 18 shows the results based on the grid 1801 and the corresponding solutions for the equations. The equations use a formula similar to the k/r potential like the familiar Newtonian formula GMm/r, but with the constant k which incorporates G and a material and calibration constant. In this equation, r=\sqrt{(xₙ)²+(yₙ)²+(Zₙ)²} is substituted so a solution for x, y and z can be obtained. The equation k/r=measured value is produced 4 times for each of the 4 boxes so that a solution for x, y, z, and k may be found as shown in FIG. 18. The value of z is the depth of the location 1812 for the natural resource of interest.

FIG. 19 is a flowchart of a process for processing amplitude in accordance with an illustrative embodiment. The process of FIG. 19 may be performed as part of the process of FIG. 7 or the other described embodiments. For example, the process of FIG. 19 may be performed as an automated algorithm, script, or other process. For example, the amplitudes of the various gravitational signals may have been measured by one or more sensor systems for additional analysis. The process may begin by finding amplitudes for natural resources of interest (step 1902). As previously disclosed, the natural resources of interest may include minerals, water, hydrocarbons, or other natural components. Step 1902 may be performed after the fast Fourier transform this performed for the sensor measurements.

Next, the system establishes a grid based on locations of these sensor systems (step 1904). The system may layout an X, Y, and Z grid based on locations of the sensors systems. The layout of the grid may be arbitrary or may be selected based on determined symmetry or positioning of the sensors systems within and exploration area. For example, based on the placement of the sensor systems some symmetry determinations may be possible.

Next, the system reduces calculation complexities by finding symmetry for the positioned sensor systems (step 1906). Symmetry within the position sensor systems may be determined, if possible. For example, for multiple sensor systems, the system may position or superimpose a grid, such that each sensor system is in a different quadrant of the grid (i.e., +x+y, −x+y, +x−y, −x−y). The potential symmetry of the sensor systems may be utilized to reduce equation, layout, map, and calculation complexity.

Next, the system establishes equations for determining a constant and locations associated with the natural resources of interest utilizing the amplitudes (step 1908). For example, the measured amplitude for each mineral type after performing a fast Fourier transform may be equal to k/\sqrt{(xₙ)²+(yₙ)²+(zₙ)²}.

Next, the system solves for x, y, z, and k utilizing the equations for each of the natural resources of interest (step 1910). The system solves x, y, z, and k for each natural resource of interest. In one embodiment, the locations and constants are automatically mapped to a mapping application, software, or interface for display or communication to the user. The amplitudes are utilized with the corresponding equations and algorithm to triangulate the natural resources detected.

Next, the system determines whether additional measurements are required (step 1912). Additional measurements may be required if additional clarity regarding the locations of the natural resources is necessary. For example, in some cases, sensor systems may have errors, failures, or calibration problems. In addition, where there are multiple natural resources of interest, additional sensor measurements and distinct locations may provide advantages. If additional measurements are not required during step 1912, the process ends.

If additional measurements are required during step 1912, the system positions these sensor systems to capture additional measurements to verify or clarify the locations (step 1914). In one embodiment, the system provides recommended locations for positioning the sensor systems. These sensor systems may be moved autonomously, automatically, or manually. Other arrangements of the sensor systems may be utilized in the same calculations or grid or separate calculations and grid to verify or clarify the results for constants and locations.

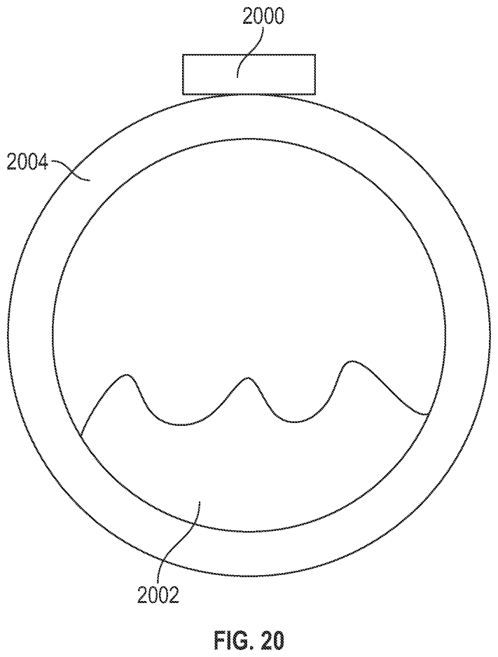

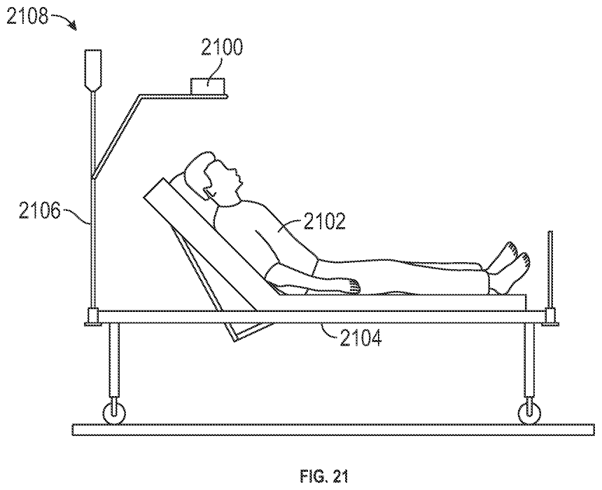

FIG. 20 is a pictorial representation of a sensor system 2000 for measuring water composition in accordance with an illustrative embodiment. The sensor system 2000 may be the gravitational sensor system 300 of FIG. 3 or any of the described embodiments, methods, and associated description (i.e., FIGS. 1-19, 21). The sensor system 2000 may be utilized to determine minerals, contaminants, or additives within the water 2002. The sensor system 2000 may represent a sensor system, such as the gravitational sensor system of FIG. 3. In one embodiment, the sensor system 2000 may not include a global positioning system or chip.

As shown the water may be stored or flowing within the receptacle 2004. The receptacle 2004 may represent any number of pipes, tanks, channels, vessels, tubes, or so forth. The same process described in the various embodiments may be utilized for determining the water composition, additives, minerals, contaminants, purity/impurity, or so forth. The sensor system 2000 may be placed proximate or on the receptacle 2004. In one embodiment, the receptacle 2004 is vibrationally separated or dampened so that any motion or vibrations within the receptacle 2004 do not affect the measurements of the sensor system 2000.

To ensure that water measurements were accurate and viable the sensor system 2000 was utilized to perform a rough test in multiple locations to perform measurements above the receptacle 2004 when empty and then when filled with water. The increases in the measurements of water were significant (i.e., moving from an amplitude of 13 background to a 31 measurement for water for location 1, and moving from an amplitude of 24 background to a 31 measurement for location 2). In location 2, after dissolving magnesium sulfate in the water, the magnesium sulfate went from 16 magnesium sulfate background to a 23 magnesium sulfate measurement. The water measurement went from 31 background to water to a 20 water measurement. Background measurements may be associated with pipes nearby water or other background measurements.

FIG. 21 is a pictorial representation of a sensor system 2100 for measuring water and material composition of a user 2102 in accordance with an illustrative embodiment. The sensor system 2100 may be positioned above the user 2102. The sensory system 2100 may also be integrated in clothing, hats, accessories (e.g., wheelchair, hospital bed, walker, vehicle, etc.), decorations, or so forth to perform measurements on the user 2102. As shown, the sensor system 2100 is integrated with a hospital bed 2104. For example, a support structure 2106 may support the sensor system 2100 above the user 2102 at a location 2108.

In one embodiment, the sensor system 2100 may determine the water content, material composition, or contaminants present in the body of the user 2102 or changing within the user 2102. The sensor system 2100 may represent one or more sensors. In one embodiment, the sensor system 2100 may include four or more sensor units that may be utilized to detect water volumes, body composition, minerals, densities, contaminants, and so forth. The sensor system 2100 may even identify the location of minerals or contaminants in the user 2102, such as arsenic in the liver, plastics in the lungs, heavy metals in the kidneys, chemicals in the reproductive system, and so forth. The sensor system 2100 may also identify quantities of water within different quadrants of the body.

The sensor system 2100 may also be mounted above a wheelchair, sitting chair, home bed, office desk, couch, or other location. The sensor system 2100 may also be integrated in the roof of a vehicle, ceiling of a room, or other location where the user 2102 spends significant time. In one embodiment, the sensor system 2100 may perform measurements for the user when at the location. For example, the sensor system 2100 may perform measurements of the user when seated at an office desk off and on throughout the day when the user is seated in a target area.

FIG. 22 shows a table 2200 of exemplary material data in accordance with an illustrative embodiment. The following table 2200 (also labeled Table 1 in the description) presents an example of material density, characteristic frequency, measured frequency based on the earth signal (with changes based on lunar and planetary effects and relative position on the surface of the earth), and minimum measurement time (in days). The “HW95 tidal potential catalogue” previously described by Torsten Hartmann and Hans-George Wenzel as originally published on 15 Dec. 1995 may be referenced. The table 2200 may be referenced when performing calculations, analysis, processing, and predictions as are herein described.

TABLE 1

| | | | frequency | Minimum |
|---|---|---|---|---|
| | | Characteristic | based on Earth | Measurement |
| Material | Density (g [symbol] | Freq [symbol] | (Hz) | Time(days) |
| Natural gas | 0.000657 | 75.04438058 | 0.000858508 | 0.080889715 |
| Lithium | 0.534 | 2.632268784 | 3.01132E−05 | 2.306116536 |
| Oil | 0.8 | 2.150581317 | 2.46027E−05 | 2.822640801 |
| Light Crude | 0.875 | 2.056349053 | 2.35246E−05 | 2.951988409 |
| Water | 1 | 1.923538406 | 2.20053E−05 | 3.155808353 |
| Heavy crude | 1.2 | 1.755942292 | 2.0088E−05 | 3.457014845 |
| Lithium Brine | 1.36 | 1.649420576 | 1.88694E−05 | 3.68027334 |
| shale | 1.8 | 1.433720878 | 1.64018E−05 | 4.233961201 |
| Silver | 10.49 | 0.593899716 | 6.79421E−06 | 10.22111714 |
| Lead | 11.35 | 0.570956381 | 6.53174E−06 | 10.63184294 |
| Palladium | 12.02 | 0.554815554 | 6.34709E−06 | 10.94114706 |
| Rhodium | 12.41 | 0.546028072 | 6.24656E−06 | 11.11722799 |
| Tungsten | 19.25 | 0.438415091 | 5.01547E−06 | 13.84605296 |
| Gold | 19.3 | 0.437846828 | 5.00897E−06 | 13.86402318 |
| Platinum | 21.45 | 0.415324178 | 4.75131E−06 | 14.61585648 |
| sea water | 1.025 | 1.899935814 | 2.17353E−05 | 3.195012445 |
| micro plastics | 0.9 | 2.02758751 | 2.31956E−05 | 2.993862677 |
| Calcium | 1.55 | 1.545023228 | 1.76751E−05 | 3.928949715 |
| asteroid | 3 | 1.110555417 | 1.27048E−05 | 5.466020407 |
| Thulium | 9.32 | 0.630075954 | 7.20807E−06 | 9.634264773 |
| Yttrium | 4.47 | 0.909802447 | 1.04081E−05 | 6.67212821 |
| Samarium | 7.52 | 0.701442283 | 8.0245E−06 | 8.654052822 |
| Promethium | 7.26 | 0.71389206 | 8.16693E−06 | 8.503132211 |
| praseodymium | 6.8 | 0.737643306 | 8.43864E−06 | 8.229341363 |
| lanthanum | 6.145 | 0.775961044 | 8.87699E−06 | 7.822968203 |
| Neodymium | 7 | 0.72702918 | 8.31721E−06 | 8.349484089 |
| Osmium | 22 | 0.410099766 | 4.69154E−06 | 14.80205324 |
| Wollastonite | 2.975 | 1.115211854 | 1.2758E−05 | 5.443197675 |
| Marble | 2.58 | 1.197542704 | 1.36999E−05 | 5.068978794 |
| Aluminum | 2.7 | 1.170628195 | 1.3392E−05 | 5.185522267 |
| copper | 8.96 | 0.642609079 | 7.35145E−06 | 9.446362909 |
| Propane | 0.5 | 2.720294102 | 3.11202E−05 | 2.231493487 |
| Arsenic | 5.3 | 0.835531692 | 9.55848E−06 | 7.265216427 |
| diamond | 3.5 | 1.028174527 | 1.17623E−05 | 5.903976818 |
| Wollastonite in Marble | 7.8 | 0.688737232 | 7.87915E−06 | 8.813693076 |
| Iridium | 22.56 | 0.404977891 | 4.63295E−06 | 14.98925918 |

[symbol]

indicates data missing or illegible when filed

The illustrative embodiments provide an enhanced system, method, network, platform, and devices for identifying and locating natural resources. The natural resources may include elements, minerals, boundaries (e.g., bedrock, layers, etc.) and other compositions in ground, a body of a user or animal, in water (e.g., pipe, reservoir, river, lake, aquifer, etc.). Gravitational resonances are measured by a sensor system including an accelerometer. The gravitational resonances are slow moving waves or signals that change over time. From the FFT of these signals, an amplitude is determined based on the frequency which determined from Equation 26.

$${Mineral}_{Frequency} = 1.1 \times {10}^{- 5} Hz * \sqrt{\frac{Density\_bedrock}{density\_mineral}}$$

The bedrock density may be determined (or assumed if known) by working backwards from the known water frequency. After knowing the frequency and finding the amplitude, this information is utilized to triangulate between other measurements of the same frequency (e.g., minerals) and then locate the depth and the ore grade (or gallons per minute if water) of the material. Each mineral density corresponds a unique frequency and the amount of time that data is samples determines the frequency resolution of the density measurements. The longer the time measurements are taken, the higher the resolution between two or more densities. No other material with a different density will interfere with the measurement of a material of a given density as those measurements will fall in different bins of the frequency spectrum.

The features, steps, and components of the illustrative embodiments may be combined in any number of ways and are not limited specifically to those described. In particular, the illustrative embodiments contemplate numerous variations in the smart devices and communications described. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the invention. It is understood that any other modifications, substitutions, and/or additions may be made, which are within the intended spirit and scope of the disclosure. The previous detailed description is of a small number of embodiments for implementing the invention and is not intended to be limiting in scope. The following claims set forth a number of the embodiments disclosed with greater particularity.

What is claimed:

1. A method for locating natural resources, the method comprising:
capturing sensor measurements at four or more locations utilizing sensor instruments including at least an accelerometer;
converting the sensor measurements into digital data;
performing a fast fourier transform on the digital data;
identifying natural resources proximate the locations utilizing the digital data;
performing triangulation for the natural resources that are identified;
generating a report showing predictions for the natural resources and triangulation data for the natural resources.

2. The method of claim 1, wherein the sensor measurements are captured at 1 Hz or slower.

3. The method of claim 1, wherein the sensor instruments are stand-alone devices that are water resistant and battery powered.

4. The method of claim 1, wherein the triangulation data is a three-dimensional location.

5. The method of claim 1, wherein the report is a keyhole markup language (KML) file.

6. The method of claim 1, wherein the predictions include at least a type of the natural resources and location of the natural resources in three dimensions.

7. The method of claim 1, further comprising:
saving the sensor measurements to a memory associated with each of the sensor instruments.

8. The method of claim 1, wherein the performing, identifying, and generating are performed by a system.

9. The method of claim 1, wherein the sensor measurements are within a range of 1 microhertz to 100 microhertz.

10. The method of claim 1, wherein the sensor instruments are buried in ground or mounted to a secure fixture.

11. A sensor system comprising:
a battery powering electronic components of the sensor system;
a power switch for activating and deactivating the electrical components of the sensor system;
a global positioning system that determines a location of the sensor system;
one or more accelerometers capturing sensor measurements associated with a target area, wherein the sensor measurements are within a range of 1 microhertz to 100 microhertz received for the target area, and wherein the one or more accelerometers are vibrationally dampened;
an analog-to-digital converter converting the sensor measurements to data;
a memory securely storing the data for analysis, wherein the electrical components of the sensor system are enclosed in a waterproof housing.

12. The sensor system of claim 11, wherein the sensor system performs measurements within the target area for greater than two weeks.

13. The sensor system of claim 11, wherein the sensor system is one of at least four sensor systems performing measurements for the target area.

14. The sensor system of claim 11, further comprising:
one or more filters in communication with the analog-to-digital converter for truncating the data above 0.01 Hz to cut-off earth frequencies and moon frequencies.

15. A system for measuring natural resources in an exploration area, the system comprising:
one or more sensor systems measuring signals as sensor measurements for an exploration area to detect the natural resources, wherein the one or more sensor systems include at least a high-definition accelerometer for performing the sensor measurements;
a computing device that receives the sensor measurements from the one or more sensor systems, wherein the computing device analyzes the sensor measurements to generate data, and generates one or more predictions regarding at least types of natural resources and locations of the natural resources in the exploration area utilizing the data.

16. The system of claim 15, further comprising:
a database in communication with the computing device, the database configured to securely store the sensor measurements.

17. The system of claim 15, wherein analyzing the sensor measurements includes at least performing an automatic fast Fourier transform of the sensor measurements to generate the one or more predictions utilizing the data.

18. The system of claim 15, wherein the sensor measurements are in a range of 1 microhertz to 100 microhertz that are stored in a memory in communication with the accelerometer.

19. The system of claim 15, wherein the one or more sensor systems are at least four sensor systems, and wherein the one or more sensor systems each include a transceiver for communicating directly or indirectly with the computing device.

20. The system of claim 15, wherein the one or more predictions including at least a KML file of the natural resources showing at least one or more locations of the natural resources in three dimensions.
